(19) United States
(12) Patent Application Publication
(10) Pub. No.: US 2013/0328804 A1
(43) Pub. Date: Dec. 12, 2013

(54) INFORMATION PROCESSING APPARATUS, METHOD OF CONTROLLING THE SAME AND STORAGE MEDIUM

(71) Applicant: CANON KABUSIKI KAISHA, Tokyo (JP)

(72) Inventors: Soshi Oshima, Tokyo (JP); Yuji Naya, Kawasaki-shi (JP)

(73) Assignee: CANON KABUSIKI KAISHA, Tokyo (JP)

(21) Appl. No.: 13/887,537

(22) Filed: May 6, 2013

(30) Foreign Application Priority Data
Jun. 8, 2012 (JP) 2012-131394

(51) Int. Cl. G06F 3/0484

(52) U.S. Cl. CPC G06F 3/04842
USPC 345/173

(57) ABSTRACT

Provided is an information processing apparatus equipped with a display unit including a touch panel, and a method of controlling the same. In response to a plurality of fingers of a user that are in touch with a display object displayed on the display unit including the touch panel moving in the same direction, the touched display object is displayed such that they move, and the moving display object and a plurality of display objects displayed within a predetermined distance thereof are displayed as a grouped display object. With an operation performed by the user on the grouped display object, delete processing for deleting objects corresponding to a plurality of display objects included in the grouped display objects is executed.

### BACKGROUND OF THE INVENTION

1. Field of the Invention

The present invention relates to an information processing apparatus that displays objects on a touch panel and can execute processing on the objects through a touch operation of a user, and a method of controlling the same.

2. Description of the Related Art

As a technology for deleting a page object (hereinafter referred to as “object”) such as an electronic document that is constituted by a plurality of pages, a technology for selecting an object to be deleted using a mouse pointer and then deleting the object is well known. In this technology, however, the delete operation is divided into a plurality of steps consisting of selection and deletion, and is therefore complicated for an operator.

In order to solve such a problem, Japanese Patent Laid-Open No. 2009-294857 proposes a technology for deleting an object by an operation of a user using a multi-touch UI that can recognize touch of a plurality of fingers. In the invention of this document, object delete processing is assigned to a multi-touch gesture in which at least one finger is fixed on the object and another finger is moved.

However, in the above-described conventional method, when deleting a plurality of objects, the object delete gesture needs to be performed with respect to each of the objects. Therefore, the object delete gesture must be performed as many times as the number of objects to be deleted, making the operation troublesome.

### SUMMARY OF THE INVENTION

An aspect of the present invention is to eliminate the above-mentioned problems which are found in the conventional technology.

A feature of the present invention is to provide a technique in which operability is improved when deleting objects displayed on a screen.

According to an aspect of the present invention, there is provided an information processing apparatus equipped with a display unit having a touch panel, comprising: a grouping unit configured to display, in response to a plurality of touch points of at least one display object that is being touched among a plurality of display objects displayed on the display unit moving in the same direction, the touched display object so as to move in the direction, and to display the moving display object and a plurality of display objects displayed within a predetermined distance thereof, as a grouped display object; and a deleting unit configured to execute delete processing for deleting objects that correspond to the plurality of display objects grouped by the grouping unit, by a user operation performed on the grouped display object displayed by the grouping unit.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating a hardware configuration of an information processing apparatus according to an embodiment.

FIG. 2 is a block diagram illustrating a configuration of a software module executed by a CPU of the information processing apparatus according to the embodiment.

FIGS. 3A to 3G depict views illustrating examples of touch information generated through touch input by a user on a touch panel of the information processing apparatus according to the embodiment.

FIG. 4 is a flowchart for describing gesture event generation processing performed by the information processing apparatus.

FIGS. 5A to 5M depict views illustrating a list of event names that are to be generated in flowcharts of FIGS. 6, 7, 9, 10A and 10B, and pieces of information that are to be transmitted to a gestural event processing section when the corresponding event has been generated.

FIG. 6 is a flowchart for describing processing that is associated with touch of a new finger of the user in step S404 in FIG. 4.

FIG. 7 is a flowchart for describing processing that is associated with movement of the finger of the user in step S406 in FIG. 4.

FIGS. 8A and 8B depict views illustrating an aspect in which the user performs a rotation operation on a touch panel in a clockwise direction.

FIG. 9 is a flowchart for describing processing that is associated with touch release in step S408 in FIG. 4.

FIGS. 10A and 10B are flowcharts for describing processing that is associated with timer interrupt in step S409 in FIG. 4.

FIG. 11 is a block diagram illustrating a delete processing module provided in the gestural event processing section of an information processing apparatus according to a first embodiment.

FIGS. 12A and 12B are flowcharts for describing processing performed by the delete processing module according to the first embodiment and a second embodiment.

FIG. 13A is a flowchart for describing processing for selecting a display object.

FIG. 13B is a flowchart for describing cancellation of selection of a display object.

FIG. 14 is a flowchart for describing processing for grouping display objects with both hands according to the first embodiment.

FIG. 15 is a flowchart for describing processing for deleting display objects with one hand according to the first and second embodiments.

FIGS. 16A and 16B are flowcharts for describing processing for completing operations of the first and second embodiments.

FIG. 17 is a flowchart for describing processing for grouping display objects with one hand according to the second embodiment of the present invention.

FIG. 18 is a flowchart for describing processing for completing the processing for grouping display objects with one hand according to the second embodiment.

FIGS. 19A to 19E depict views illustrating examples of object information of display objects that correspond to the display objects in FIGS. 21A and 21B.

FIGS. 20A to 20D depict views schematically illustrating a flow of processing from grouping a plurality of objects displayed on the touch UI of the information processing apparatus processing according to the first embodiment with both hands, to deleting them.

FIGS. 21A and 21B depict views illustrating a state in which display objects are grouped and displayed.

FIG. 22 depicts a view illustrating an aspect in which display objects displayed on the touch UI are respectively selected by three fingers on each hand.

FIG. 23 depicts a view illustrating rectangular coordinates in the first and second embodiments.

FIGS. 24A to 24C depict views illustrating an aspect in which objects are selected with one hand and grouped one by one on the object 2 in the second embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

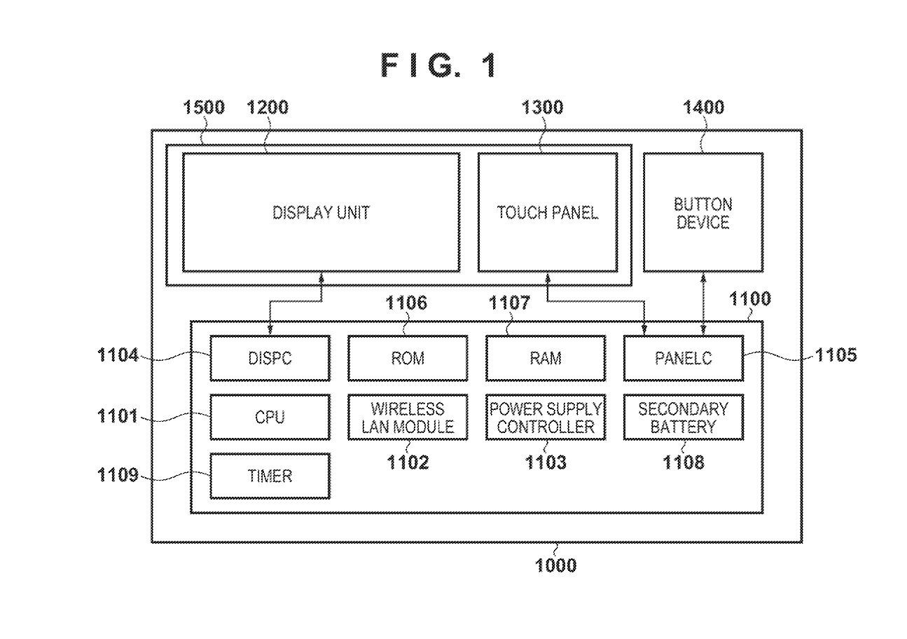

FIG. 1 is a block diagram illustrating a hardware configuration of an information processing apparatus 1000 according to the present embodiment.

The information processing apparatus 1000 is mainly provided with a main board 1100, a display unit 1200 such as a liquid crystal display unit, a touch panel 1300, and button devices 1400. Also, the display unit 1200 and the touch panel 1300 are collectively referred to as a touch UI 1500.

The main board 1100 includes a CPU 1101, a wireless LAN module 1102, a power supply controller 1103, a display controller (DISPC) 1104, and a panel controller (PANELC) 1105. The main board 1100 further includes a ROM 1106, a RAM 1107, a secondary battery 1108, and a timer 1109. These parts 1101 to 1109 are connected to each other via a bus (not shown).

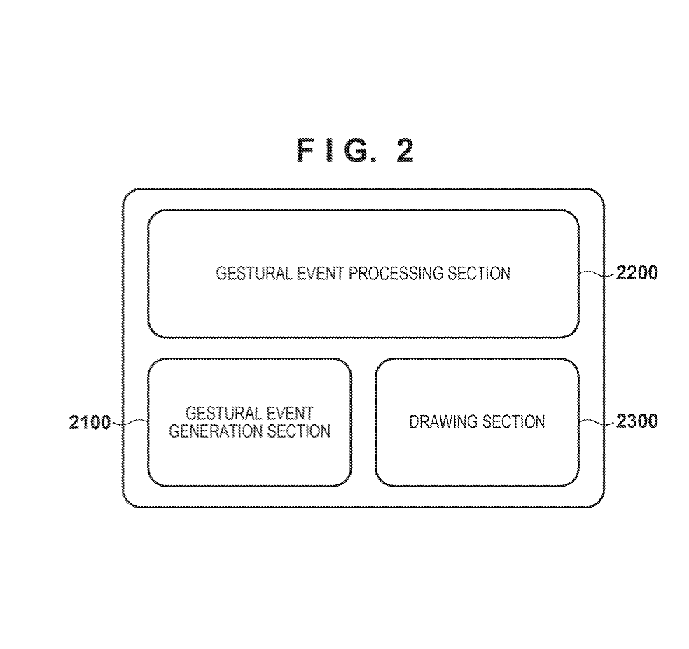

The CPU 1101 controls the devices connected to the bus, and deploys a software module (FIG. 2) of the present embodiment stored in the ROM 1106 into the RAM 1107 to execute the software module. The RAM 1107 functions as a main memory and a work area of the CPU 1101, and as a storage area for image data to be displayed on the display unit 1200.

The display controller (DISPC) 1104 switches output of the image data deployed in the RAM 1107 at a high speed in accordance with a request of the CPU 1101, and outputs a synchronization signal to the display unit 1200. As a result, the image data stored in the RAM 1107 is output to the display unit 1200 in synchronization with the synchronization signal output by the DISPC 1104, and an image that corresponds to the image data is displayed on the display unit 1200.

The panel controller (PANELC) 1105 controls the touch panel 1300 and the button devices 1400 in accordance with a request of the CPU 1101. With this control, the CPU 1101 is notified of a touch point on the touch panel 1300 at which a finger or an instruction tool such as a stylus pen touches, a key code that corresponds to a touched key on the button devices 1400, or the like. The touch point information includes a coordinate value that indicates an absolute position in the lateral direction of the touch panel 1300 (hereinafter referred to as the “x-coordinate”), and a coordinate value that indicates an absolute position in the vertical direction (hereinafter referred to as the “y-coordinate”). The touch panel 1300 is capable of detecting multiple simultaneous touch points, and in this case, the CPU 1101 is notified of pieces of touch point information equal in number to the number of the touch points. Note that the touch panel 1300 may be any of various types of touch panel systems such as a resistive membrane system, a capacitance system, a surface acoustic wave system, an infrared ray system, an electromagnetic induction system, an image recognition system, or a light sensor system.

The power supply controller 1103 is connected to an external power supply (not shown) and supplied with electric power. Accordingly, the power supply controller 1103 supplies the entire information processing apparatus 1000 with electric power while charging the secondary battery 1108 connected to the power supply controller 1103. When no electric power is supplied from the external power supply, electric power from the secondary battery 1108 is supplied to the entire information processing apparatus 1000. The wireless LAN module 1102 establishes wireless communication with a wireless LAN module of another device in accordance with control of the CPU 1101, and mediates communication with the information processing apparatus 1000. An example of the wireless LAN module 1102 is an IEEE 802.11b wireless LAN module. The timer 1109 generates a timer interrupt to a gestural event generation section 2100 (FIG. 2) in accordance with control of the CPU 1101. The gestural event generation section 2100 will be described later with reference to FIG. 2.

FIG. 2 is a block diagram illustrating a configuration of a software module executed by the CPU 1101 of the information processing apparatus 1000 according to the embodiment. Note that this software module is realized by the CPU 1101 deploying and executing, in the RAM 1107, a program stored in the ROM 1106.

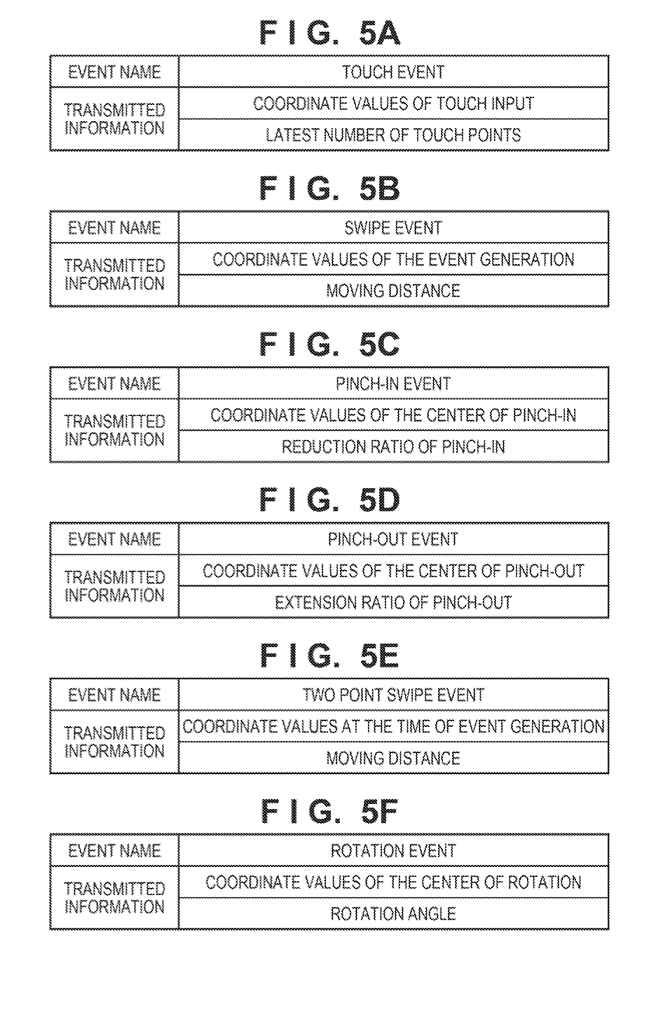

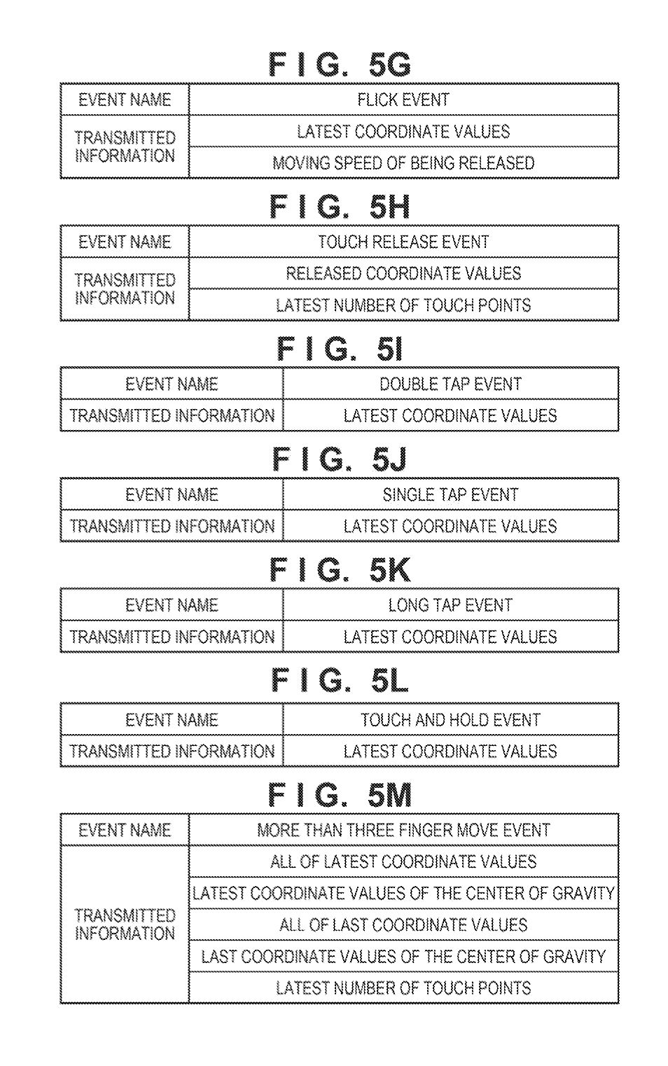

Upon receipt of a touch input on the touch panel 1300 by a user, the gestural event generation section 2100 generates various types of gestural events shown in FIGS. 5A to 5M. The gestural event generation section 2100 transmits the generated gestural events to a gestural event processing section 2200. The gestural event processing section 2200 receives the gestural events generated in the gestural event generation section 2100, and executes processing that corresponds to each gestural event. A drawing section 2300 executes drawing processing on the display unit 1200 in accordance with the results of the processing executed by the gestural event processing section 2200.

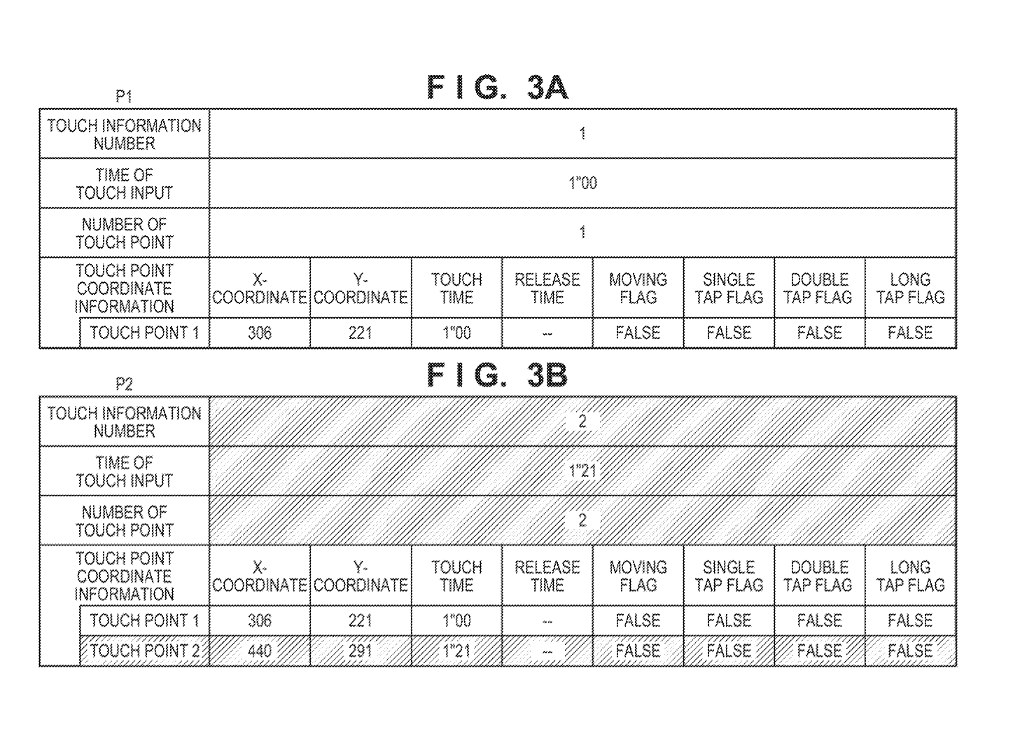

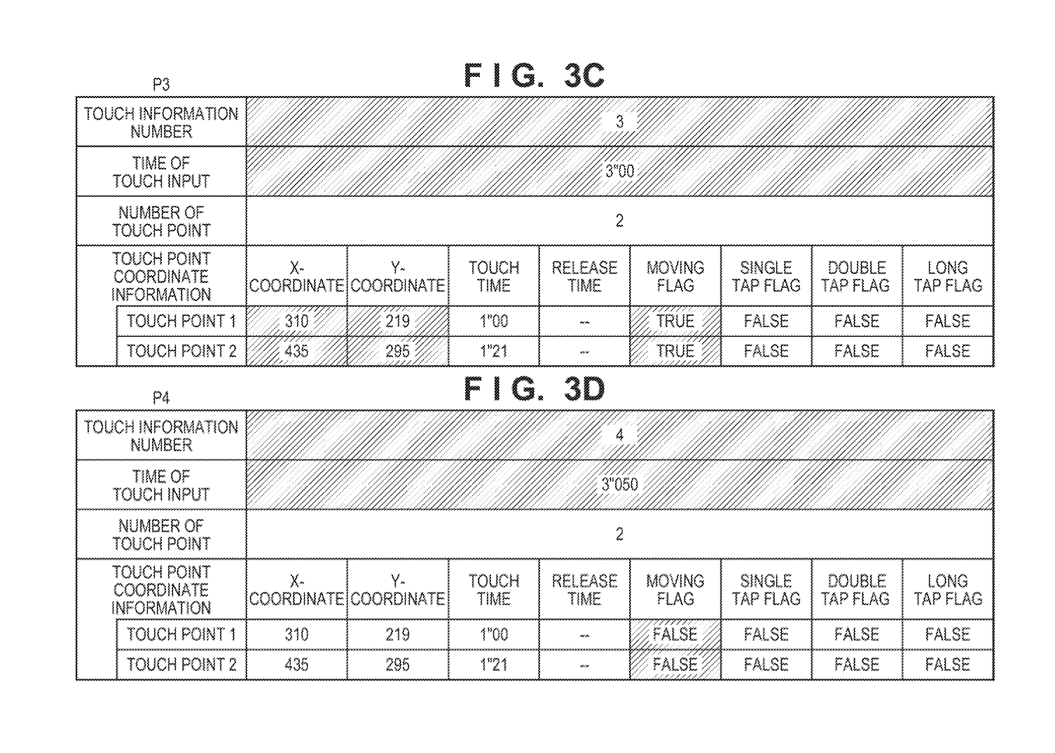

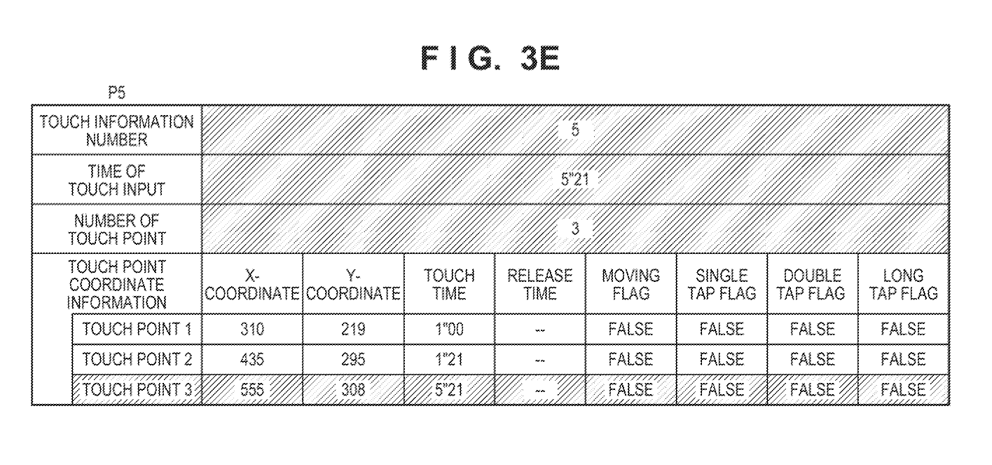

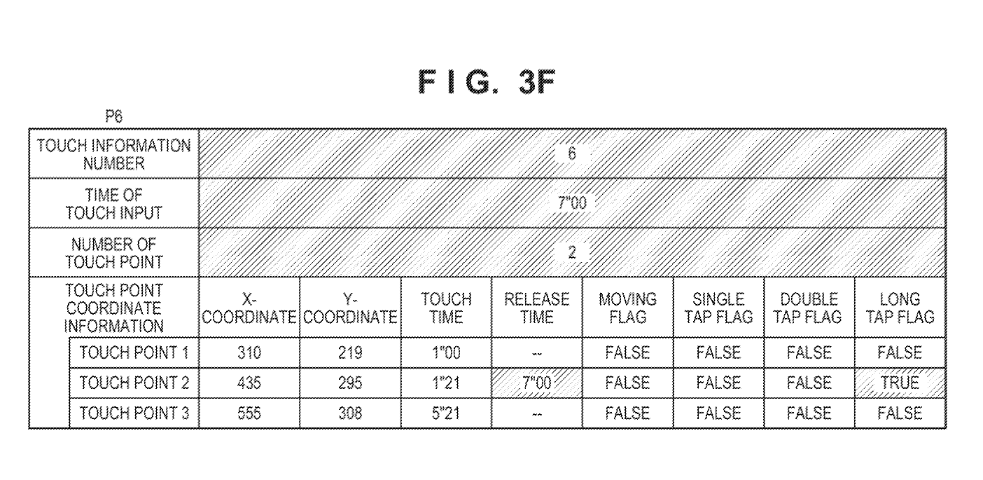

The gestural event generation section 2100 will be described in detail later with reference to FIGS. 3A to 10.

FIGS. 3A to 3G are diagrams illustrating examples of touch information generated through touch input by a user on the touch panel 1300 of the information processing apparatus 1000 according to the embodiment. Although, here, finger touch input is taken as an example of the touch input by the user, the touch input may be input through a stylus pen or the like.

The touch information includes, as illustrated in FIG. 3A, touch information number, time of touch input, the number of touch points, and touch point coordinate information. Hereinafter, the constituent elements of the touch information will be described in detail. Note that in FIGS. 3A to 3G, the time of touch input is expressed only in seconds or smaller values, with hours and minutes being omitted.

The touch information number indicates the order in which the corresponding touch information is generated. The time of touch input indicates time when touch input on the touch panel 1300 was performed by the user. The number of touch points indicates the number of sets of coordinates at which the user performs touch input (for example, the number of fingers that are touching the panel). The touch point coordinate information indicates information relating to coordinates of a point at which the user performs touch input, and includes an x-coordinate, a y-coordinate, a touch time, a release time, a moving flag, a single tap flag, a double tap flag, and a long tap flag. The following will describe the constituent elements of this touch point coordinate information in detail.

An x-coordinate and a y-coordinate of the touch point coordinate information indicate coordinate values of one point on the touch panel 1300 at which a finger of the user touches. The touch time and the release time respectively indicate the time when this finger touches the touch panel 1300, and the time when this finger is released from the touch panel 1300. The moving flag indicates that the finger of the user is moving on the touch panel 1300. The single tap flag indicates that a single tap was made on the touch panel 1300 by the finger of the user. Here, “single tap” refers to an operation in which the finger of the user is released within a predetermined period of time after touching the touch panel 1300. The double tap flag indicates that a double tap was made on the touch panel 1300 by the finger of the user. Here, “double tap” refers to an operation in which a single tap is made in succession within a predetermined period of time. The long tap flag indicates that a long tap has been made on the touch panel 1300 by the finger of the user. Here, “long tap” refers to an operation in which the finger of the user does not move while continuing to touch the touch panel 1300 for a predetermined period of time after touching the touch panel 1300.

The touch point coordinate information obtains an entity that is, for example, a touch point 1 as shown in FIG. 3A, when the finger of the user touches the touch panel 1300. The touch point 1 has the values of the x-coordinate, the y-coordinate, the touch time, the release time, the moving flag, the single tap flag, the double tap flag, and the long tap flag in accordance with the constituent elements of the touch point coordinate information, as shown in FIG. 3A.

FIGS. 3A to 3G respectively illustrate examples of the touch information. FIGS. 3A to 3G are arranged in time series, and each indicate a piece of touch information of a certain point of time. Also, the pieces of touch information shown in FIGS. 3A to 3G are generated in order from FIG. 3A to FIG. 3G in accordance with the operation of the finger of the user. In FIGS. 3B to 3G, the shaded regions denote regions that have different touch information from that of the last touch information.

When touch information is generated, a pointer indicating the generated touch information is stored. Therefore, by referencing this pointer, it is possible to reference the values of latest touch information. Also, all pointers of touch information generated in the past are stored, and therefore it is possible to reference all values of the held touch information. For example, touch information immediately before the latest touch information can be referenced. However, a predetermined number of pieces of touch information are held as past history, and when the number of pieces of touch information has exceeded the predetermined number, the touch information is discarded from the oldest information. The eliminated touch information cannot be referenced.

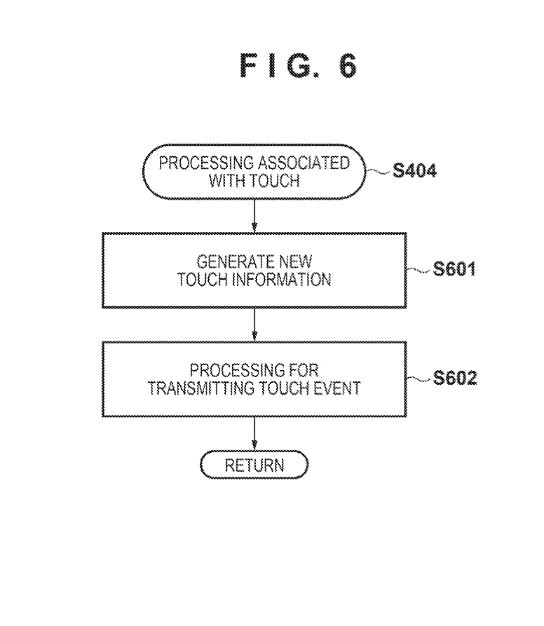

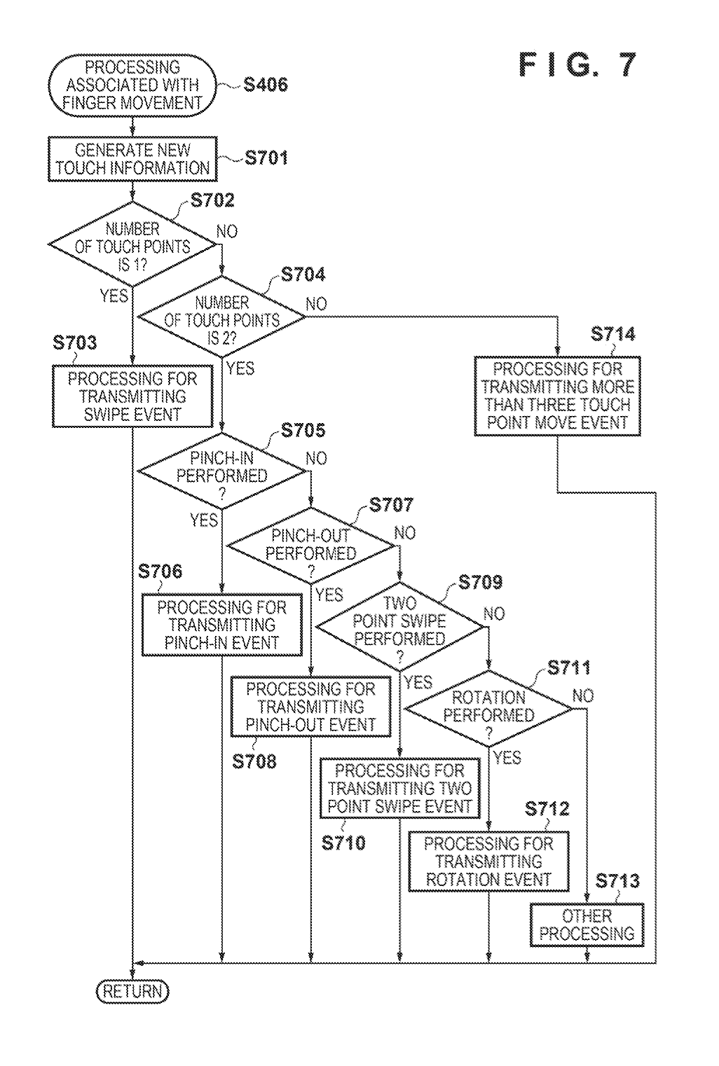

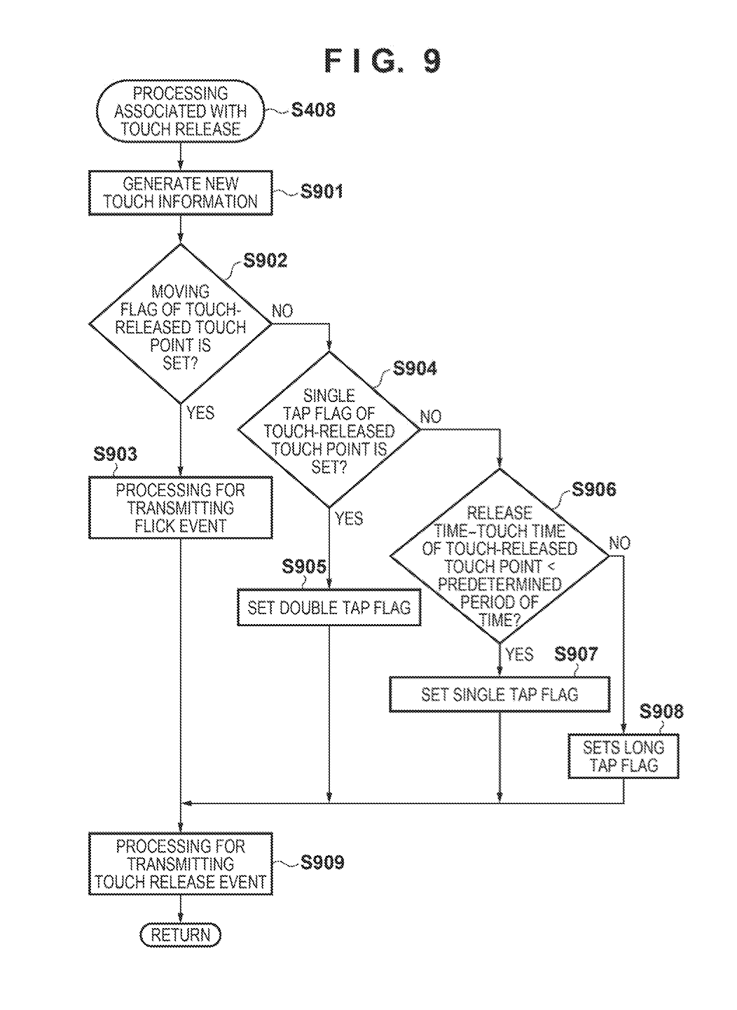

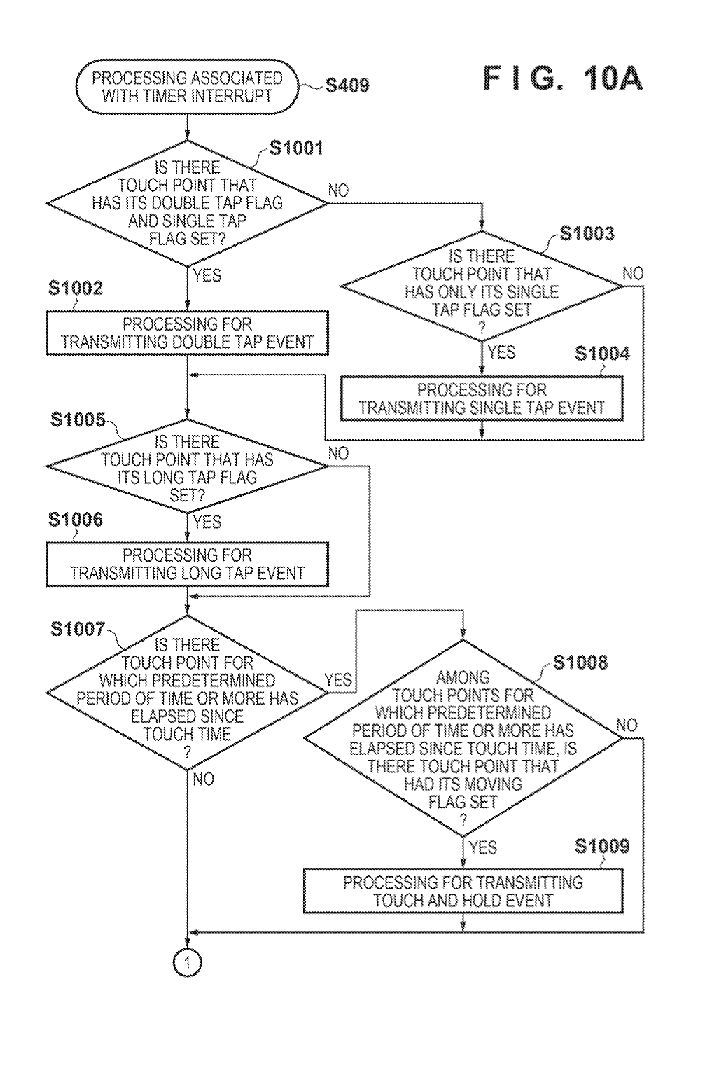

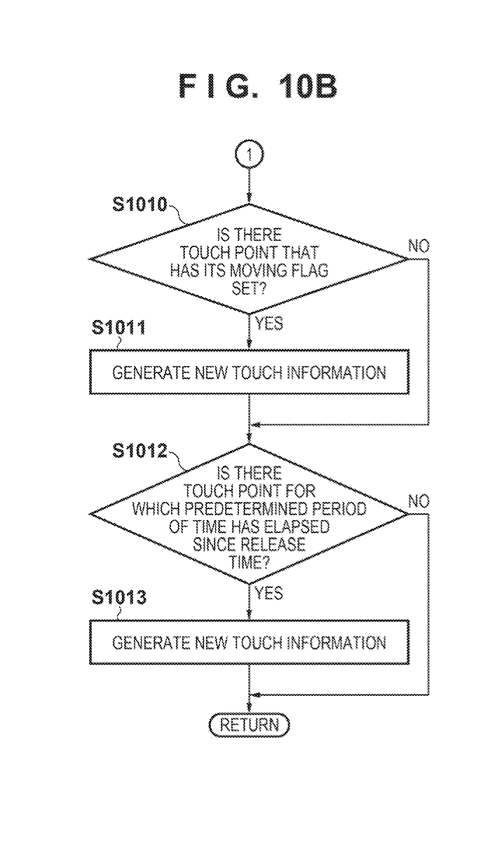

The examples of the touch information illustrated in FIGS. 3A to 3G will briefly be described. All the pieces of touch information are generated in step S601 in FIG. 6, step S701 in FIG. 7, step S901 in FIG. 9, or step S1011 or step S1013 in FIG. 10B.

Touch information P1 of FIG. 3A is generated when a finger of the user first touches the touch panel 1300, and generated in later-described step S601. At this time, the touch point 1 indicates the values of touch point coordinate information of the finger of the user.

Touch information P2 of FIG. 3B is generated when the last touch information is the touch information P1 of FIG. 3A and a second finger of the user touches the touch panel 1300, and is generated in later-described step S601. At this time, a touch point 2 indicates the values of touch point coordinate information of the second finger.

Touch information P3 of FIG. 3C is generated when the last touch information is the touch information P2 of FIG. 3B and the two fingers of the user are moving on the touch panel 1300, and is generated in later-described step S701. At this time, moving flags of the touch points 1 and 2 show “TRUE”, indicating that the two fingers are moving. In FIG. 3C, the x-coordinates and the y-coordinates change but the touch time does not change.

Touch information P4 of FIG. 3D is generated when the last touch information is the touch information P3 of FIG. 3C and the fingers of the user have stopped moving on the touch panel 1300, and is generated in later-described S1011. In FIG. 3D, since the fingers of the user have stopped moving, the x-coordinates and the y-coordinates are the same as those in FIG. 3C, and the moving flags of the touch points 1 and 2 show “FALSE”, indicating that the fingers of the user have stopped moving.

Touch information P5 of FIG. 3E is generated when the last touch information is the touch information P4 of FIG. 3D and a third finger of the user touches the touch panel 1300, and is generated in later-described step S601. At this time, the touch points 1 and 2 are at the same coordinates as those in FIG. 3D, and the newly added touch point 3 indicates the values of touch point coordinate information of the third finger.

Touch information P6 of FIG. 3F is generated when the last touch information is the touch information P5 of FIG. 3E and the second finger of the user is released from the touch panel 1300, and is generated in later described step S901 in FIG. 9. The release time of the touch point 2 shows the time when the second finger is released. In FIG. 3F, the x-coordinates, the y-coordinates, and the touch times of the touch points 1 to 3 are not changed and the long tap flag of the touch point 2 is changed to “TRUE”. This is because the second finger was touching the touch panel 1300 continuously for six seconds without moving.

Touch information P7 of FIG. 3G is generated by timer interrupt of the timer 1109 when the last touch information is the touch information P6 of FIG. 3F, and is generated in later-described step S1013 in FIG. 10B. It is clear that, at this time, the touch point 2 has been deleted. The processing for generating the above-described touch information will be described later with reference to flowcharts in FIGS. 6, 7, 9, and 10.

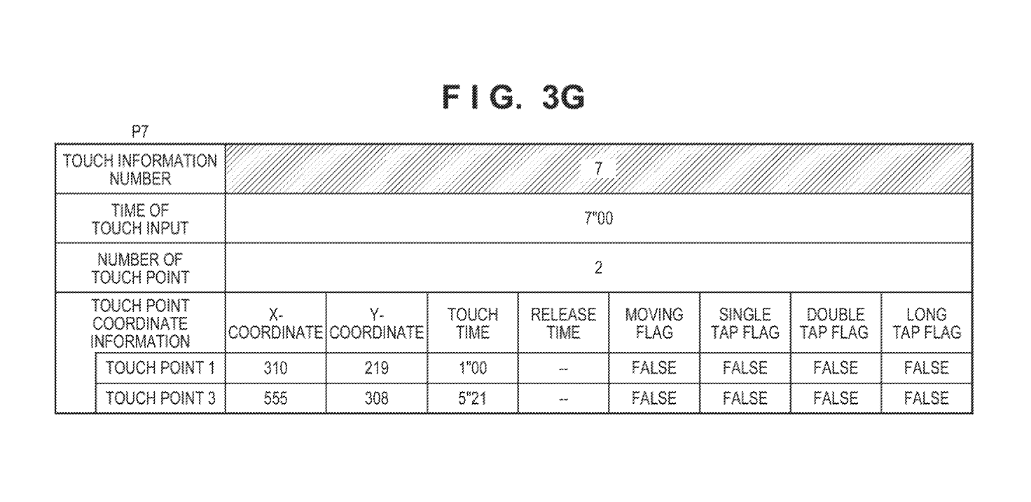

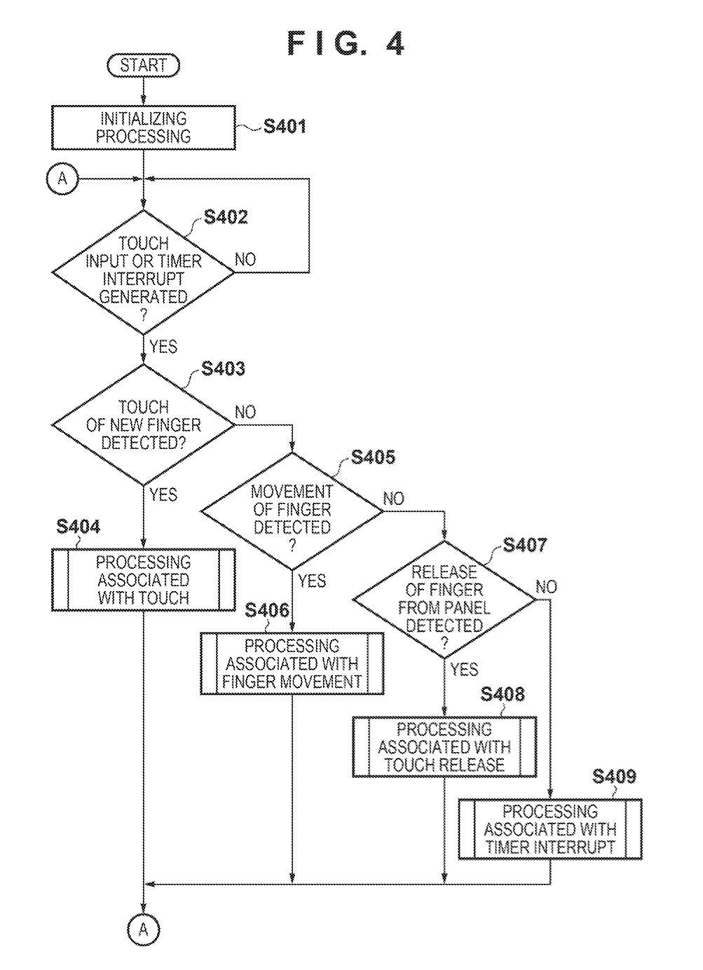

FIG. 4 is a flowchart for describing gesture event generation processing performed by the information processing apparatus 1000 according to the embodiment. This flowchart shows processing from detection of a touch input on the touch panel 1300 by the user until generation of event processing corresponding to each gesture operation of the user. This processing is executed by the gestural event generation section 2100 of the software module, and is described here as processing that is executed by the CPU 1101.

First, in step S401, the CPU 1101 initializes touch information P that shows the state of finger touch, as initializing processing. Next, the procedure advances to step S402, and the CPU 1101 determines whether or not a touch input of the user or an interrupt of the timer 1109 has occurred, and if the touch input or the interrupt has occurred, the procedure advances to step S403, and otherwise the procedure returns to step S402. In step S403, the CPU 1101 determines whether or not touch of a new finger of the user has been detected, and if touch of a new finger has been detected, the procedure advances to step S404, and otherwise the procedure shifts to step S405. In step S404, the CPU 1101 executes processing associated with the touch of a new finger of the user and the procedure returns to step S402. The details of step S404 will be described later with reference to the flowchart of FIG. 6.

In step S405, the CPU 1101 determines whether or not movement of the finger of the user that is touching the touch panel has been detected, and if the movement has been detected, the procedure advances to step S406, and otherwise the procedure shifts to step S407. In step S406, the CPU 1101 executes processing associated with the movement of the finger of the user, and the procedure returns to step S402. The details of step S406 will be described later with reference to the flowchart in FIG. 7.

In step S407, the CPU 1101 determines whether or not release of the finger of the user from the touch panel 1300 has been detected, and if the finger has been released, the procedure advances to step S408, in which processing associated with touch release by the user is executed, and returns to step S402. The details of this step S408 will be described later with reference to the flowchart in FIG. 9. In contrast, in step S407, if the release of the finger has not been detected, the procedure shifts to step S409. In step S409, the CPU 1101 executes processing that is performed when an interrupt of the timer 1109 has occurred, and returns to step S402.

FIGS. 5A to 5M depict views illustrating a list of event names that are generated in the flowcharts of FIGS. 6, 7, 9, and 10, and pieces of information that are transmitted to the gestural event processing section 2200 from the gestural event generation section 2100 when a corresponding event is generated.

FIG. 6 is a flowchart for describing processing that is associated with touch of a new finger of the user in step S404 in FIG. 4.

First, in step S601, the CPU 1101 generates new touch information if the last touch information does not exist. On the other hand, if the last touch information does exist, the CPU 1101 changes the touch information number, the time of touch input, and the number of touch points of this last touch information. Further, touch information that incorporates a touch point of the new finger that touched the touch panel is generated (see FIG. 3B).

Here, “last touch information” refers to touch information that was generated immediately before the touch information generated in step S601. Also, “latest touch information” refers to the touch information generated in step S601. For example, in FIG. 3A, since the last touch information does not exist, a touch input of one point is detected, and the touch information P1 is newly generated. Also, if with next touch input, a touch input of the second point has been detected in step S403, the touch information P2 of FIG. 3B is generated with reference to the touch information P1 of FIG. 3A. The shaded regions in FIG. 3B are regions that differ from those in FIG. 3A. Specifically, the touch information number is changed to “2”, the time of touch input is changed to “1” 21”, the number of touch points is changed to “2”, and the “touch point 2” that corresponds to touch input of the second finger of the user is added. Further, if a touch input of the third point (third finger) has been detected, the touch information P5 of FIG. 3E is similarly generated with reference to the touch information P4 of FIG. 3D.

As described above, when the touch information has been generated, the procedure advances to step S602, and the CPU 1101 executes processing for transmitting a touch event. As illustrated in FIG. 5A, in the processing for transmitting a touch event, coordinate values of the touch input and the number of touch points, which are the latest pieces of touch information, are transmitted to the gestural event processing section 2200 and the processing associated with touch of the finger of the user ends.

FIG. 7 is a flowchart for describing processing associated with movement of the finger of the user in step S406 in FIG. 4.

First, in step S701, the CPU 1101 changes the touch information number and the time of touch input of the last touch information, and generates touch information whose moving flag is “TRUE” (see FIG. 3C). In FIG. 7, “last touch information” refers to touch information that was generated immediately before the touch information generated in step S701. Also, “latest touch information” refers to the touch information generated in step S701.

For example, in FIG. 3C, if the last touch information is the touch information P2 of FIG. 3B, the touch information P3 of FIG. 3C is newly generated with reference to the touch information P2. Specifically, the touch information number is changed to “3”, the time of touch input is changed to “3” 00”, the values of the x-coordinates and the y-coordinates of the touch points 1 and 2 are changed to the latest values, and the moving flag is changed to “TRUE”.

Next, the procedure advances to step S702, the CPU 1101 determines whether or not the number of touch points of the latest touch information is “1”, and if it is “1”, the procedure advances to step S703, and otherwise the procedure shifts to step S704. In step S703, the CPU 1101 executes processing for transmitting a swipe event since one touch point is moving, and the procedure returns to the flowchart of FIG. 4. Here, “swipe” refers to an operation in which a fingertip moves (slides) in one direction while remaining in contact with the touch panel 1300. At this time, as illustrated in FIG. 5B, if a swipe event has been generated, the coordinate values of the latest touch information, and a moving distance obtained based on a difference in the coordinate values between the latest touch information and the last touch information are transmitted to the gestural event processing section 2200.

In step S704, the CPU 1101 determines whether or not the number of touch points of the latest touch information is “2”. If so, the procedure advances to step S705, and otherwise the procedure advances to step S714. In step S705, the CPU 1101 determines whether or not the length of a straight line that connects the two touch points has reduced, so as to determine whether or not pinch-in has been performed, and if so, the procedure advances to step S706, and otherwise the procedure advances to step S707. In step S706, the CPU 1101 executes processing for transmitting a pinch-in event, and returns to the flowchart of FIG. 4. Here, “pinch-in” refers to an operation in which two fingertips move closer to each other (in a pinching manner) while being in touch with the touch panel 1300. Accordingly, if a pinch-in event has been generated, as illustrated in FIG. 5C, the coordinate values of the center of the two touch points, and a reduction ratio of pinch-in that is calculated from the reduced length of the straight line connecting the two touch points are transmitted to the gestural event processing section 2200.

In step S707, the CPU 1101 determines whether or not pinch-out has been performed by determining whether or not the length of the straight line connecting the two touch points has extended, and if so, the procedure advances to step S708, and otherwise the procedure advances to step S709. In step S708, processing for transmitting a pinch-out event is performed and the procedure returns to the flowchart of FIG. 4. Here, “pinch-out” refers to an operation in which two fingertips move away from each other (so that the fingers spread apart) while being in touch with the touch panel 1300. When the pinch-out event has been generated, as illustrated in FIG. 5D, the coordinate values of the center of the two touch points of the latest touch information and an extension ratio of pinch-out that is calculated from an extended length of the straight line connecting the two touch points are transmitted to the gestural event processing section 2200.

In step S709, the CPU 1101 determines whether or not a two point swipe has been performed by determining whether or not the two touch points are moving in the same direction, and if it is determined that a two point swipe has been performed, the procedure advances to step S710, and otherwise the procedure advances to step S711. In step S710, the CPU 1101 performs processing for transmitting a two point swipe event and returns to the flowchart of FIG. 4. If the two point swipe event has been generated, as illustrated in FIG. 5E, values of the two touch points of the latest touch information, and a moving distance obtained based on a difference in the values of the two touch points between the latest and the last touch information are transmitted to the gestural event processing section 2200.

Next, in step S711, the CPU 1101 determines whether or not rotation has been performed on the basis of rotation of the two touch points, and if rotation has been performed, the procedure advances to step S712, and otherwise the procedure advances to step S713. In step S712, the CPU 1101 performs processing for transmitting a rotation event, and the procedure returns to the flowchart of FIG. 4. If the rotation event has been generated, coordinate values of the center of rotation that is calculated from the values of the two touch points of the latest touch information, and a rotation angle calculated from the values of the two touch points of the latest touch information and the last touch information are transmitted to the gestural event processing section 2200. This is indicated in FIG. 5F.

If it is determined that the operation did not fall under any of the above-described user operations, the CPU 1101 advances the procedure to step S713 to perform other processing, and returns to the flowchart of FIG. 4. The other processing may be processing in which nothing is performed.

Also, in step S704, if it is determined that the number of touch points of the latest touch information is not “2”, the CPU 1101 advances the procedure to step S714 to perform processing for transmitting an event that is generated when three or more touch points have moved, and the procedure returns to the flowchart of FIG. 4. If, as shown in FIG. 5M, the three or more touch point move event has been generated, the following information is transmitted to the gestural event processing section 2200. This information includes all coordinate values of the latest touch information, the latest coordinate values of the centroid calculated from all the touch points, the number of the latest coordinates, all coordinate values of the last touch information, and the last coordinate values of the centroid. With these procedures, the processing associated with finger movement ends.

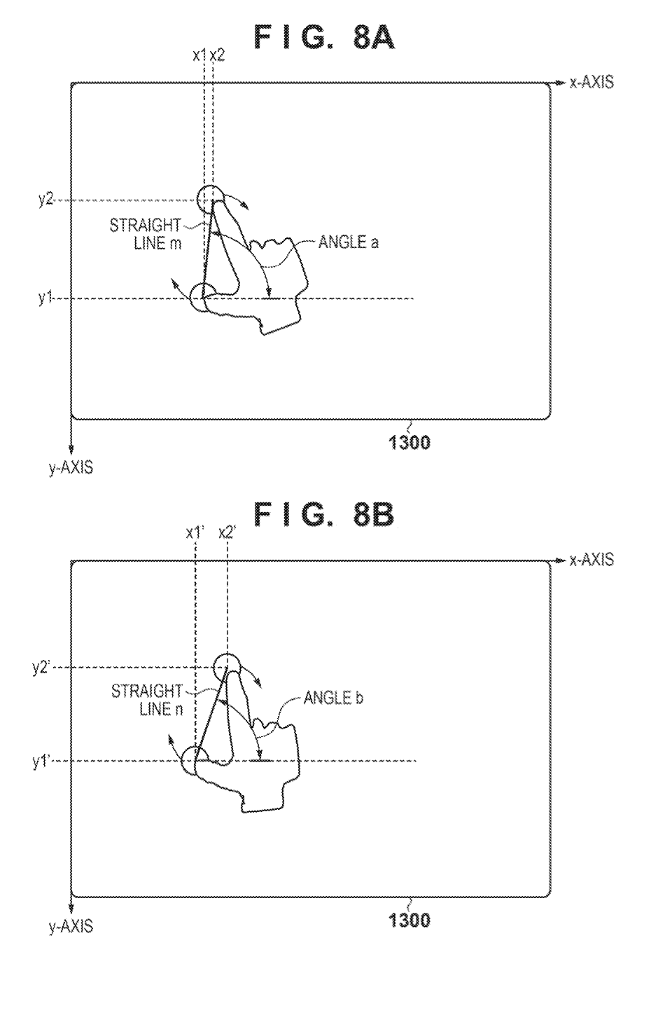

Now, the rotation event will be described in detail with reference to FIGS. 8A and 8B.

FIGS. 8A and 8B illustrate an aspect in which the user performs a rotation operation on the touch panel 1300 in a clockwise direction. In FIG. 8A, the user is in touch with two points of (x1, y1) and (x2, y2) with his or her two fingers, the coordinate values of the center of the rotation are at the center of a straight line m that connects these two points, and an angle a is an angle obtained by a line parallel to the x-axis and the straight line. On the other hand, in FIG. 8B, the user is in touch with two points of (x1′, y1′) and (x2′, y2′) with his two fingers, and coordinate values of the center of rotation are at the center of a straight line n that connects these two points, and an angle b is an angle obtained by a line parallel to the x-axis and the straight line. Assuming that FIG. 8B shows the touch points at the time of the transmission of the rotation event and FIG. 8A shows the last touch points thereof, the rotation angle is obtained by subtracting the angle b from the angle a.

FIG. 9 is a flowchart for describing processing associated with the touch release in step S408 in FIG. 4.

First, in step S901, the CPU 1101 changes the touch information number, the time of touch input, and the number of touch points of the last touch information, and generates touch information in which a release time is set when touch has been released from the touch point. In FIG. 9, “last touch information” refers to touch information that was generated immediately before the touch information generated in step S901. Also, “latest touch information” refers to the touch information generated in step S901. For example, if the last touch information is the touch information P5 of FIG. 3E, the touch information P6 of FIG. 3F is newly generated with reference to the touch information P5. Specifically, the touch information number is changed to “6”, the time of touch input is changed to “7” 00”, and the number of touch points is changed to “2”, and the release time of the coordinates 2 at which touch has been released is set to “7” 00”.

Next, the procedure advances to step S902, and the CPU 1101 determines whether or not the moving flag of the touch-released touch point in the latest touch information is “TRUE”, and if so, the procedure advances to step S903 and otherwise the procedure advances to step S904. In step S903, the CPU 1101 recognizes that the finger has been released during the movement since the moving flag of the touch-released touch point is “TRUE”, and executes processing for transmitting a flick event, and the procedure advances to step S909. Here, “flick” refers to an operation in which a finger is released (in a manner that the finger is flicked) during a swipe. If a flick event has been generated, as illustrated in FIG. 5G, the coordinate values of the latest touch information and a moving speed of the finger calculated from the coordinate values of the latest touch information and the last touch information are transmitted to the gestural event processing section 2200. Then the process advances to step S909.

In step S904, the CPU 1101 determines whether or not the single tap flag of the touch-released touch point is “TRUE”, and if so, the procedure advances to step S905, and otherwise the procedure advances to step S906. In step S905, since single tap has already been made on the touch-released touch point, the CPU 1101 gives a double tap flag to the touch-released touch point, and the procedure advances to step S909.

In step S906, the CPU 1101 determines whether or not “(release time−touch time)<predetermined period of time” applies to the touch-released touch point, and if so, the procedure advances to step S907, and otherwise the procedure advances to step S908. In step S907, since the touch has been released within a predetermined period of time, the CPU 1101 sets the single tap flag for the touch-released touch point to on, and the procedure advances to step S909. On the other hand, in step S908, since the touch has been released after the predetermined period of time has elapsed, the CPU 1101 sets a long tap flag for this touch-released touch point, and the procedure advances to step S909. In step S909, the CPU 1101 executes processing for transmitting a touch release event. If the touch release event has been generated, as illustrated in FIG. 5H, the coordinate values of the latest touch information and the number of coordinates are transmitted to the gestural event processing section 2200. With these procedures, the processing associated with the touch release ends.

FIGS. 10A and 10B are flowcharts for describing processing associated with the timer interrupt of step S409 in FIG. 4.

First, in step S1001, the CPU 1101 determines whether or not, in the latest touch information, there is a touch point whose double tap flag and single tap flag both indicate “TRUE”, and if there is such a touch point, the procedure advances to step S1002, and otherwise the procedure advances to step S1003. In step S1002, the CPU 1101 executes processing for transmitting a double tap event since the double tap flag of the touch point is set to on, and the procedure advances to step S1005. Here, if the double tap event has been generated, as illustrated in FIG. 5I, the coordinate values of the latest touch information are transmitted to the gestural event processing section 2200.

On the other hand, in step S1003, the CPU 1101 determines whether or not, in the latest touch information, there is a touch point for which only the single tap flag is “TRUE”, and if there is such a touch point, the procedure advances to the step S1004, and otherwise the procedure advances to step S1005. In step S1004, the CPU 1101 executes processing for transmitting a single tap event since the touch point has the single tap flag set, and the procedure advances to step S1005. If the single tap event has been generated, as illustrated in FIG. 5J, the coordinate values of the latest touch information are transmitted to the gestural event processing section 2200.

In step S1005, the CPU 1101 determines whether or not, in the latest touch information, there is a touch point whose long tap flag is “TRUE”, and if there is such a touch point, the procedure advances to step S1006, and otherwise the procedure advances to step S1007. In step S1006, the CPU 1101 executes processing for transmitting a long tap event since the touch point has the long tap flag set, and the procedure advances to step S1007. If the long tap event has been generated, as illustrated in FIG. 5K, the coordinate values of the latest touch information are transmitted to the gestural event processing section 2200.

In step S1007, the CPU 1101 determines whether or not, in the latest touch information, there is a touch point for which a predetermined period of time or more has elapsed since the touch time, and if there is such a touch point, the procedure advances to step S1008, and otherwise the procedure advances to step S1010 (FIG. 10B). In step S1008, the CPU 1101 searches, with respect to the touch point of the latest touch information for which a predetermined period of time or more has elapsed since touch has been made, all touch points of the past touch information, and determines whether or not there is a touch point whose moving flag has been changed to “TRUE” among the latest and the past information. If there is such a touch point, the procedure advances to step S1010, and otherwise the procedure advances to step S1009. In step S1009, the CPU 1101 executes processing for transmitting a touch and hold event because the touch point has a moving flag that has not been set once after a finger has touched the touch screen and has been held without moving for a predetermined period of time or more, and the procedure advances to step S1010. If the touch and hold event has been generated, as illustrated in FIG. 5L, the coordinate values of the latest touch information are transmitted to the gestural event processing section 2200.

In step S1010, the CPU 1101 determines whether or not there is a touch point whose moving flag has been set (TRUE), and if there is such a touch point, the procedure advances to step S1011, and otherwise the procedure advances to step S1012. In step S1011, the CPU 1101 changes the touch information number and the time of touch input of the last touch information, and generates touch information in which moving flags are set to off for all the touch points, and the procedure advances to step S1012. For example, when the last touch information is the touch information P3 of FIG. 3C, the touch information P4 of FIG. 3D is newly generated with reference to the touch information P3. Specifically, in FIG. 3D, the touch information number is changed to “4”, the time of touch input is changed to “3” 050”, and the moving flag is set to “FALSE”. Here, the reason why the time of touch input shows “3” 050” is that the timer interrupt is assumed to be generated at a 50 millisecond interval, for example.

Next, the procedure advances to step S1012, and the CPU 1101 determines whether or not there is a touch point for which a predetermined period of time has elapsed since the release time of the touch point, and if there is such a touch point, the procedure advances to step S1013, and otherwise, the processing associated with the timer interrupt ends. In step S1013, the CPU 1101 changes the touch information number of the last touch information, and generates touch information that excludes the touch point for which a predetermined period of time has elapsed since the release time. For example, the last touch information is the touch information P6 of FIG. 3F, the touch information P7 of FIG. 3G is newly generated with reference to the touch information P6. Specifically, the touch information number is changed to “7”, and the touch point 2 in FIG. 3F is deleted. With these procedures, the processing associated with the timer interrupt ends.

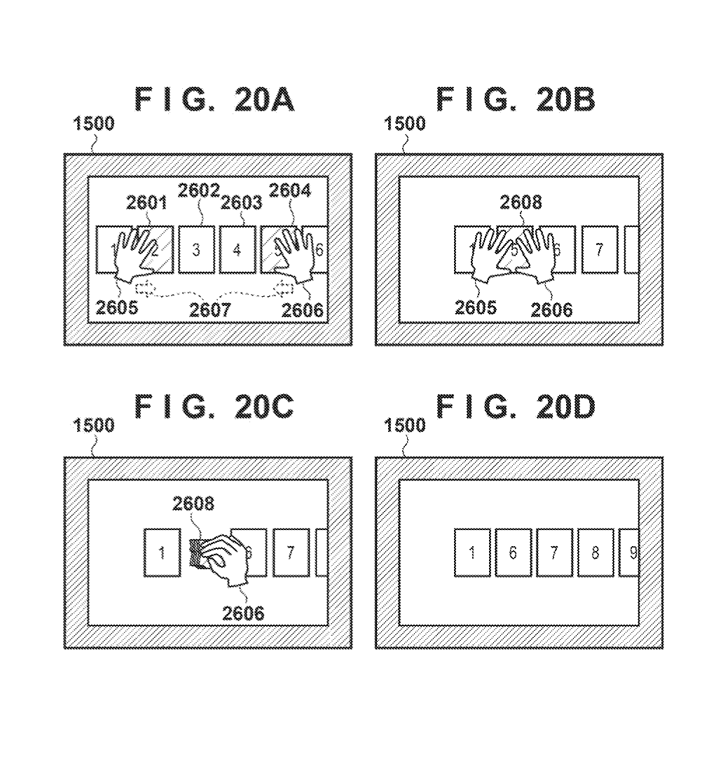

Next, an example of an operation realized in a first embodiment will be described with reference to FIGS. 20A to 20D.

FIGS. 20A to 20D depict views schematically illustrating a flow of processing from grouping a plurality of objects 2601 to 2604 displayed on the touch UI 1500 of the information processing apparatus 1000 according to the first embodiment with two hands 2605 and 2606, to deleting them.

In the first embodiment, merely “object” refers to an entity of each page object such as a PDF file, and “display object” refers to a preview image or the like of each page that is preview-displayed. Note, however, that the definition of an object is not particularly limited to this.

FIG. 20A illustrates an aspect in which display objects 2601 to 2604 each including a page object are displayed on the touch UI 1500. Here, the display objects 2601 and 2604 are respectively touched by three fingers or more of each of the two hands 2605 and 2606 and moved by the hands in the directions of arrows 2607. Accordingly, as illustrated in FIG. 20B, the display objects 2601 to 2604 are grouped into a display object 2608. This imitates the operation of collecting and stacking cards or the like with both hands.

As illustrated in FIG. 20C, the left hand 2605 is released from the touch UI 1500, and the right hand 2606 performs a multipoint pinch-in (an operation in which three or more fingers pinch together while touch the touch UI 1500). Accordingly, the display object 2608 are crumpled together like a paper ball and deleted. With this, the page objects that correspond to the display objects 2601 to 2604 are deleted.

FIG. 20D illustrates a display on the touch UI 1500 after the deletion has been completed. Here, since the page objects that correspond to the numbers 2 to 5 have been deleted, the display object of the number 6 is displayed so as to be arranged next to the display object of the number 1.

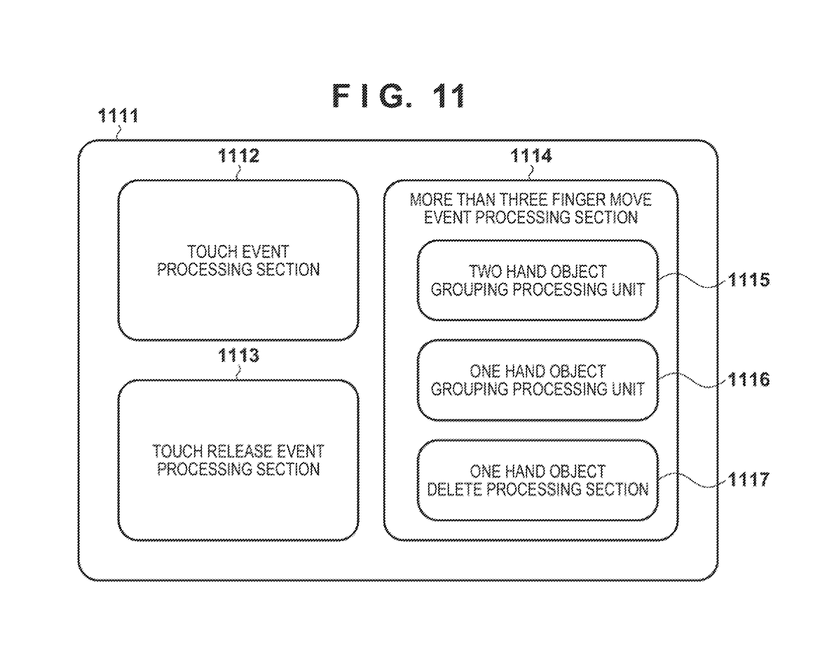

Hereinafter, the operation for grouping and deleting display objects according to the first embodiment of the present invention will be described in detail, with reference to FIGS. 11 to 16, and 19A to 23. Note that although in the first embodiment this function is realized by software on the information processing apparatus, it may be realized by a hardware module.

FIG. 11 is a block diagram illustrating a delete processing module provided in the gestural event processing section 2200 of the information processing apparatus 1000 according to the first embodiment of the present invention. This delete processing module 1111 executes processes for the touch event (FIG. 5A), the touch release event (FIG. 5H), and the three or more finger move event (FIG. 5M), which have previously been described with reference to FIGS. 5A to 5M.

A touch event processing section 1112 processes the touch event. A touch release event processing section 1113 processes the touch release event. A three or more finger move event processing section 1114 processes the three or more finger move event. A two hand object grouping processing unit 1115 of the three or more finger move event processing section 1114 executes, when a two-handed operation of the three or more finger move event has been performed, a process for grouping display objects (first embodiment). A one hand object grouping processing unit 1116 executes, when a one-handed swipe operation of the three or more finger move event has been performed, a process for grouping display objects (second embodiment). A one hand object delete processing section 1117 executes, when a multipoint pinch-in operation with one hand of the three or more finger move event has been performed, processing for deleting display objects (first embodiment).

The following will describe how to manage display data when display objects are displayed on the touch UI 1500.

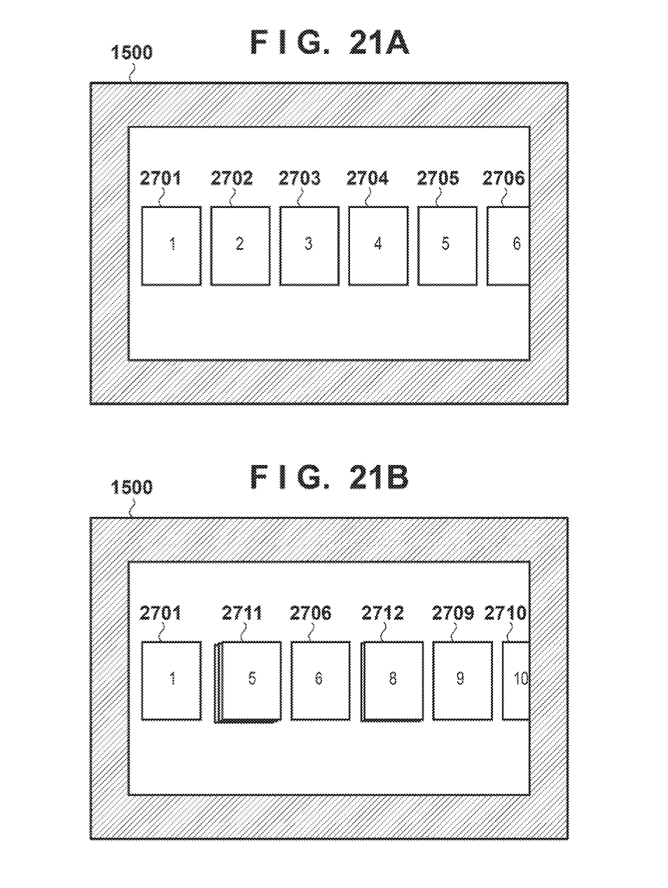

FIGS. 21A and 21B are diagrams illustrating a state in which display objects are grouped and displayed.

FIG. 21A illustrates objects 1 to 6 (the display objects 2701 to 2706) displayed on the touch UI 1500. FIG. 21B illustrates an aspect in which the objects are displayed while the objects 2 to 5(the display objects 2702 to 2705) are grouped and the objects 7 and 8 are grouped. The display object 2711 shows the state in which the objects 2 to 5 are grouped, and the display object 2712 shows the state in which the objects 7 and 8 are grouped. Reference numerals 2709 and 2710 denote display objects corresponding to objects 9 and 10.

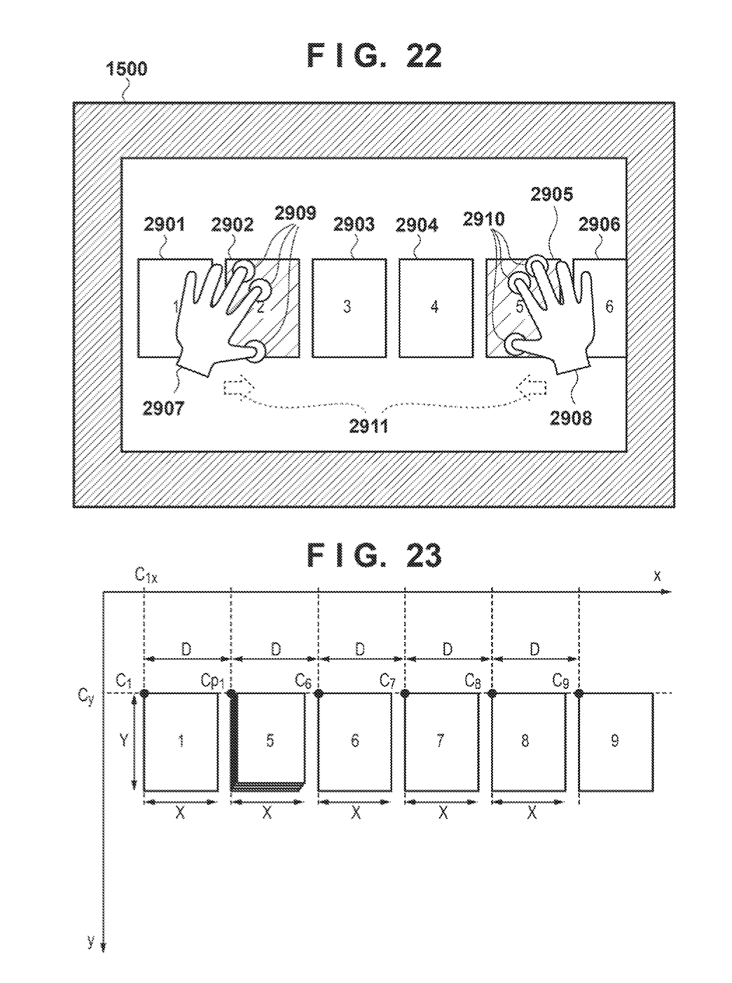

FIG. 22 illustrates an aspect in which, among the display objects 2901 to 2906 displayed on the touch UI 1500, the display objects 2902 and 2905 are respectively selected by three fingers 2909 and 2910 of each of the two hands 2907 and 2908.

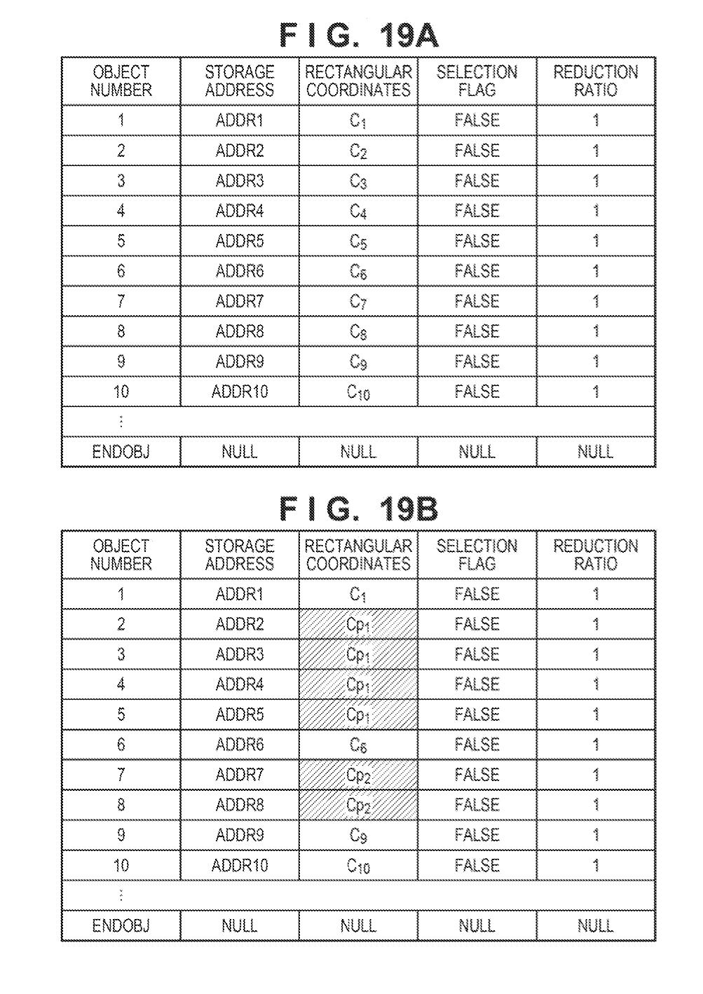

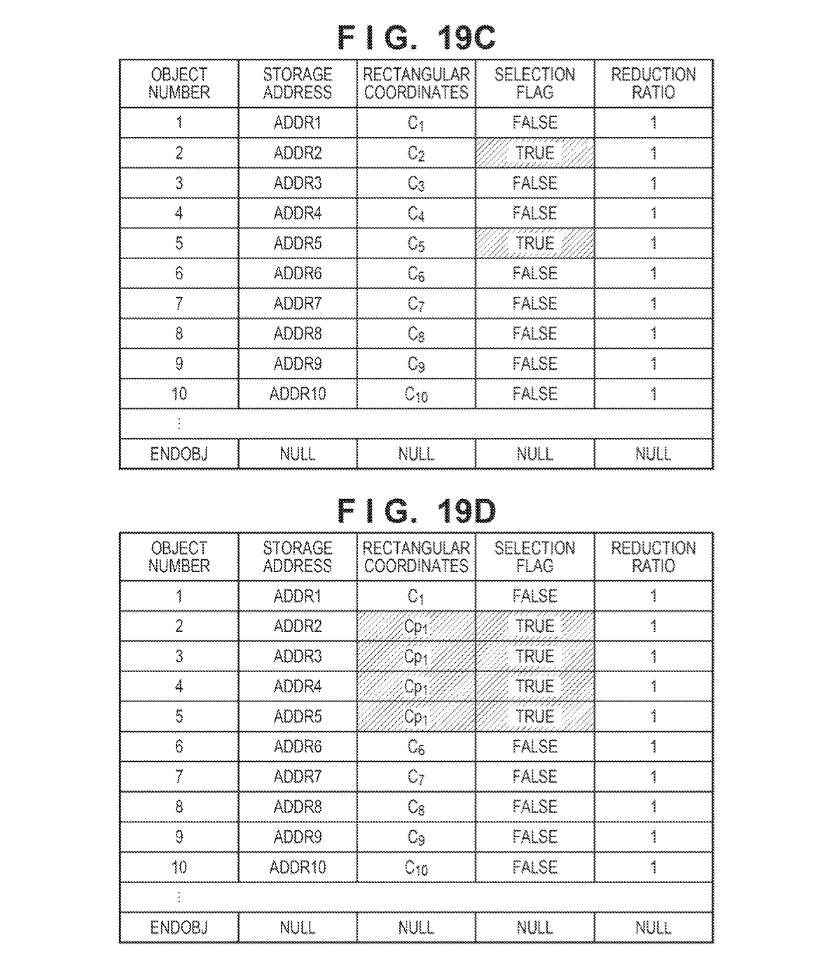

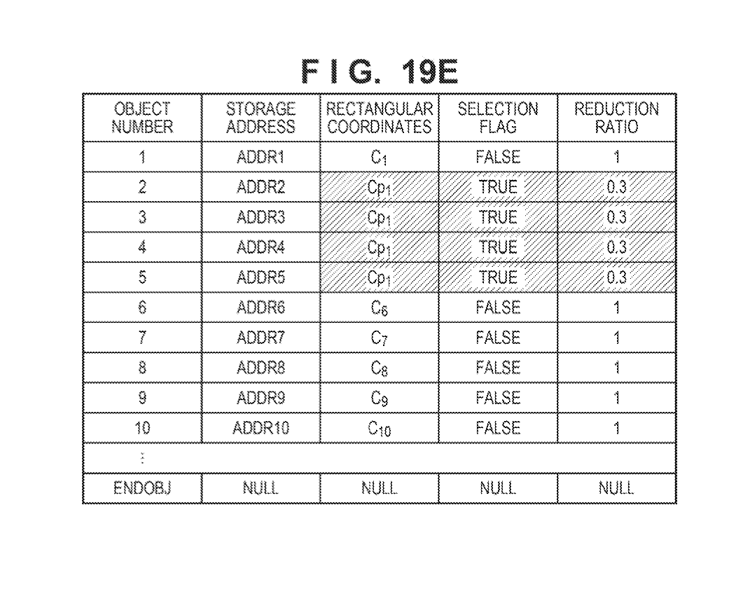

FIGS. 19A to 19E depict views illustrating examples of object information of display objects that correspond to the display objects in FIGS. 21A and 21B. Management of the states of these display objects is performed based on the pieces of object information illustrated in FIGS. 19A to 19E. This is data that is held in the RAM 1107, and can be read from and written into the delete processing module 1111. The drawing section 2300 (FIG. 2) reads out this information, and executes drawing processing in accordance with the information.

FIG. 19A shows object information that indicates a state in which, as illustrated in FIG. 21A, objects are preview-displayed. Object number is an ID of an object with which the object can uniquely be identified, and that corresponds to the object number in FIG. 21A. Storage address shows an address in the RAM 1107 where each object is stored. Rectangular coordinates are coordinates of the position on the touch UI 1500 at which the upper left corner of a rectangle showing the corresponding display object is located. Selection flag is a flag that indicates whether or not the corresponding display object is selected, and namely, when it is selected, the selection flag is “TRUE”, and otherwise, the selection flag is “FALSE”. Reduction ratio is a ratio that shows, when processing for deleting display objects is performed, to what extent the deletion has proceeded. At the end of the object information, “ENDOBJ”, which shows the end of the object information, is stored in a column of the object number. Also, in this case, it is assumed that all values such as address and the like indicate “NULL”.

FIG. 23 illustrates rectangular coordinates of the display objects according to the first embodiment. Here, the upper left corner of the touch UI 1500 is assumed to be (x, y)=(0, 0), in which the horizontal axis is an x-axis and the vertical axis is a y-axis. Rectangular coordinates C1, and C6 to C9 denote the respective coordinates of the display object, and rectangular coordinates Cp1 denote coordinates of the grouped display objects. Specifically, as illustrated in FIG. 21B, the grouped objects are the display objects 2 to 5. In this manner, one set of rectangular coordinates is defined for the grouped objects, and therefore serves as an ID of the display object. With respect to the size of each display object, X denotes the horizontal length thereof, Y denotes the vertical length thereof, and adjacent rectangular coordinates are arranged on the screen with a fixed distance D therebetween.

FIG. 19B illustrates a state in which, as illustrated in FIG. 21B, the objects of the object numbers 2 to 5 (display objects 2702 to 2705) are grouped and the objects of the object numbers 7 and 8 are grouped. Note that rectangular coordinates Cp1 in FIG. 19B denotes the coordinates of the grouped display objects 7 and 8 (corresponding to the display object 2712 in FIG. 21B), and corresponds to the coordinates C7 of the display object 7 in FIG. 23.

FIG. 19C illustrates a state in which, as illustrated in FIG. 22, the display object 2902 of the object number 2 and the display object 2905 of the object number 5 are selected.

FIG. 19D illustrates a state in which the objects 2 to 5 are grouped together and selected.

FIG. 19E illustrates a state in which the objects 2 to 5 are grouped together and are instructed to be deleted through the multipoint pinch-in as illustrated in FIG. 20C, and the deletion has proceeded by 30%, with the reduction ratio of the objects 2 to 5 in FIG. 19E indicating “0.3”.

The drawing section 2300 reads out these pieces of information, and displays preview images of the display objects in respective rectangular regions. It is determined whether or not there are objects that have the same set of rectangular coordinates among the object information, and if there are such objects, the same display objects are displayed in the same rectangular region. At this time, the display objects to be created are images displayed such that objects having the same set of rectangular coordinates are stacked on each other (see FIG. 21B). Also, with respect to the object that has a selection flag set, an image of the display object indicating that the display object is selected (for example, with a highlighted color) is created (see FIG. 22). Also, with respect to an object whose reduction ratio is less than 1, an image of the object reduced based on this reduction ratio is created, and displayed as a display object (see reference numeral 2608 in FIG. 20C). For example, in the case of FIG. 19E, based on the reduction ratio 0.3 of the objects 2 to 5, images of the display objects whose sizes are reduced by 30% are created and displayed in the same rectangular region.

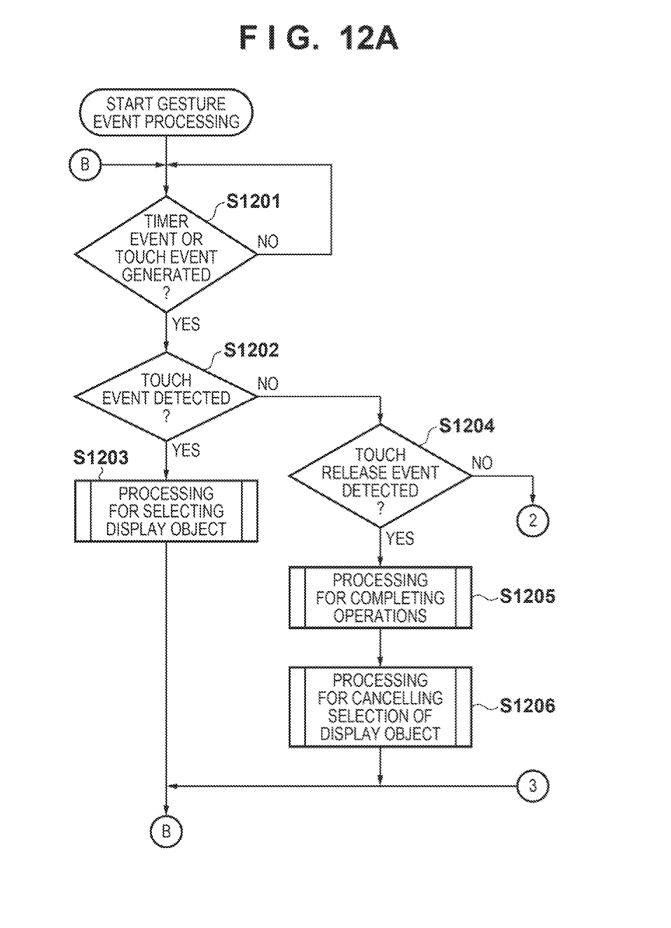

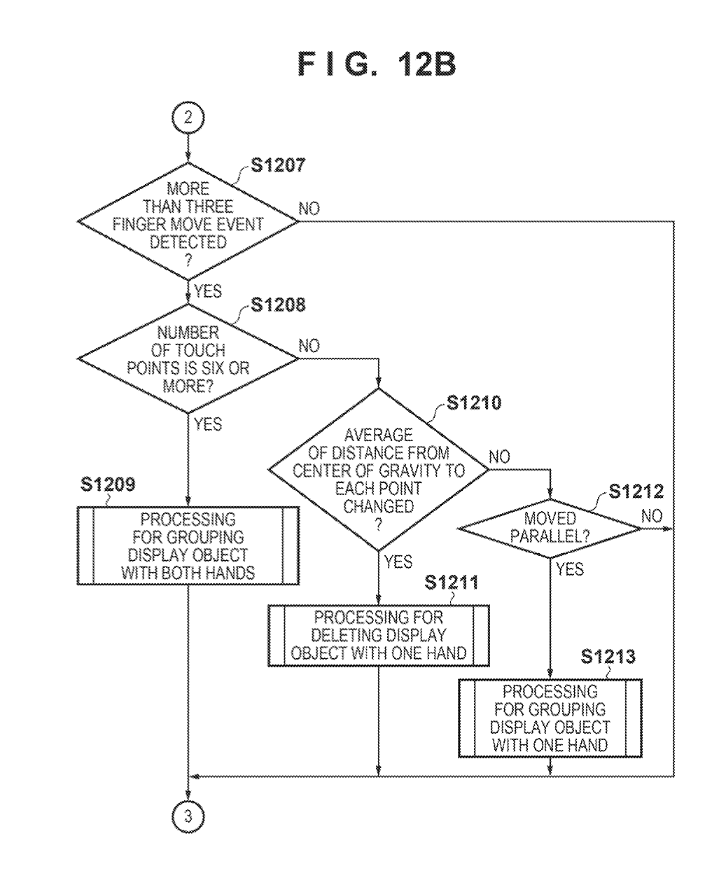

FIGS. 12A and 12B are flowcharts for describing processing performed by the delete processing module 1111 according to the first embodiment. Note that this processing module is realized by the CPU 1101 deploying, on the RAM 1107, a program stored in the ROM 1106 and executing the program.

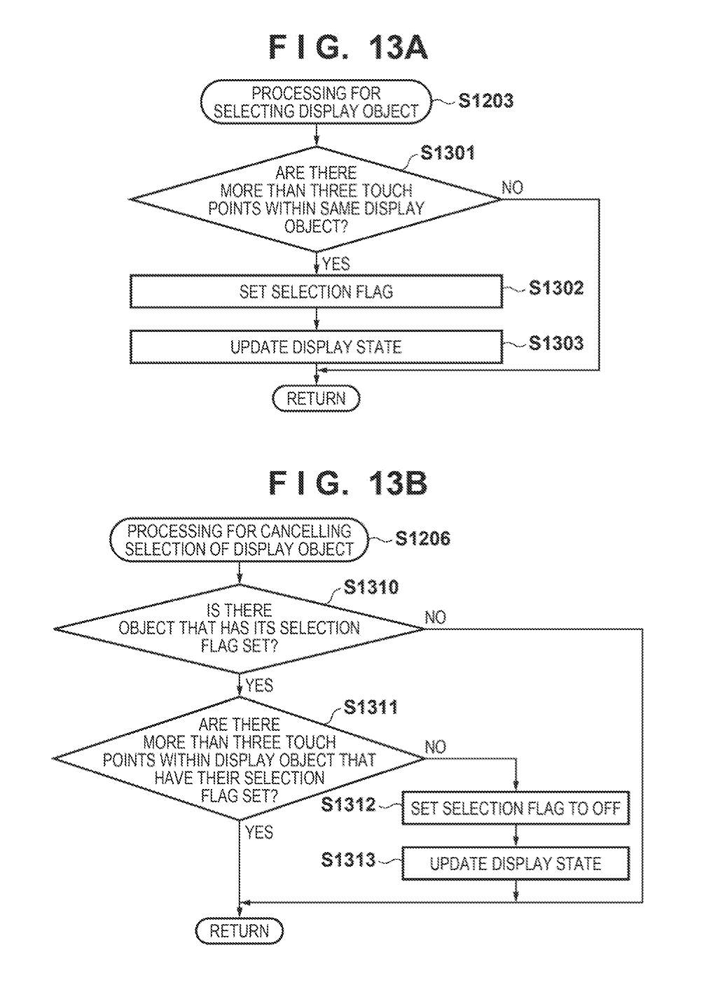

First, in step S1201, the delete processing module 1111 (CPU 1101) determines whether or not a timer event or a touch event has been generated. The timer event refers to an event that is generated periodically by an OS every predetermined period of time. If this event has been generated, the procedure shifts to step S1202, but otherwise, the procedure returns to step S1201 to determine again whether or not an event has been generated. In step S1202, the delete processing module 1111 determines whether or not the detected event is a touch event. Here, if it is a touch event, the procedure advances to step S1203, and otherwise the procedure shifts to step S1204. In step S1203, the delete processing module 1111 executes processing for selecting a display object. This processing is executed by the touch event processing section 1112 of the delete processing module 1111. The flowchart of processing for selecting a display object will be described with reference to FIG. 13A. In this manner, when the processing in step S1203 ends, the delete processing module 1111 returns the procedure to step S1201.

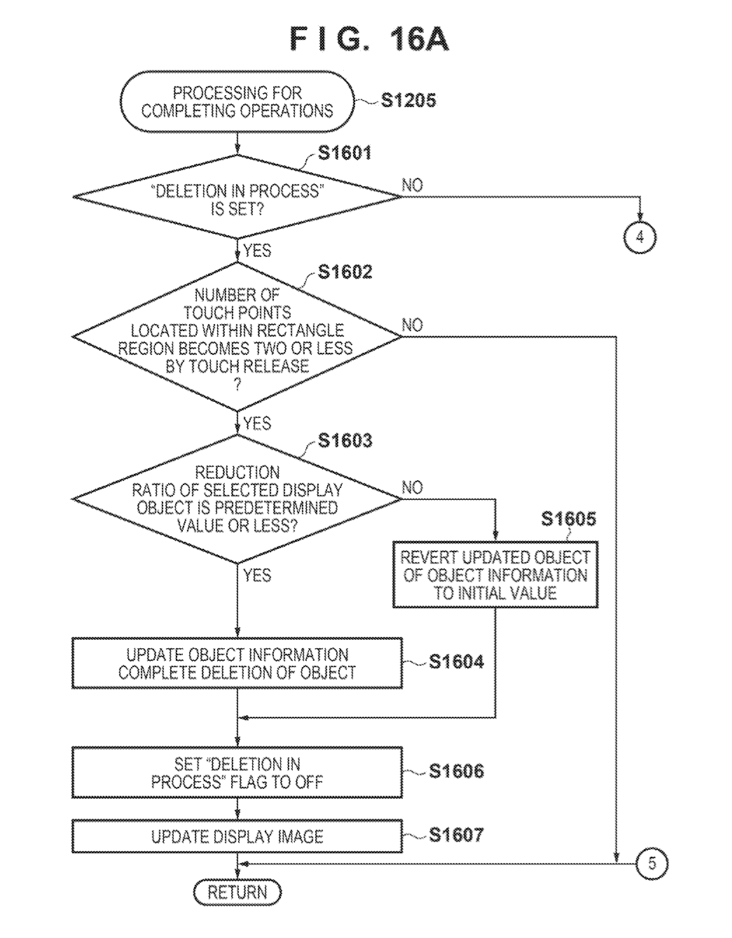

In step S1204, the delete processing module 1111 determines whether or not the detected event is a touch release event. If the detected event is the touch release event, the procedure advances to step S1205, and otherwise the procedure advances to step S1207 (FIG. 12B). In step S1205, the delete processing module 1111 executes processing for completing operations. This processing is executed by the touch release event processing section 1113 of the delete processing module 1111. The flowchart of this processing for completing operations will be described with reference to FIGS. 16A and 16B. Next, the procedure advances to step S1206, and the delete processing module 1111 executes processing for cancelling selection of the display objects. This processing is executed by the touch release event processing section 1113 of the delete processing module 1111. The flowchart of this processing will be described with reference to FIG. 13B. With this, the processing in step S1206 ends, and the delete processing module 1111 returns the procedure to step S1201.

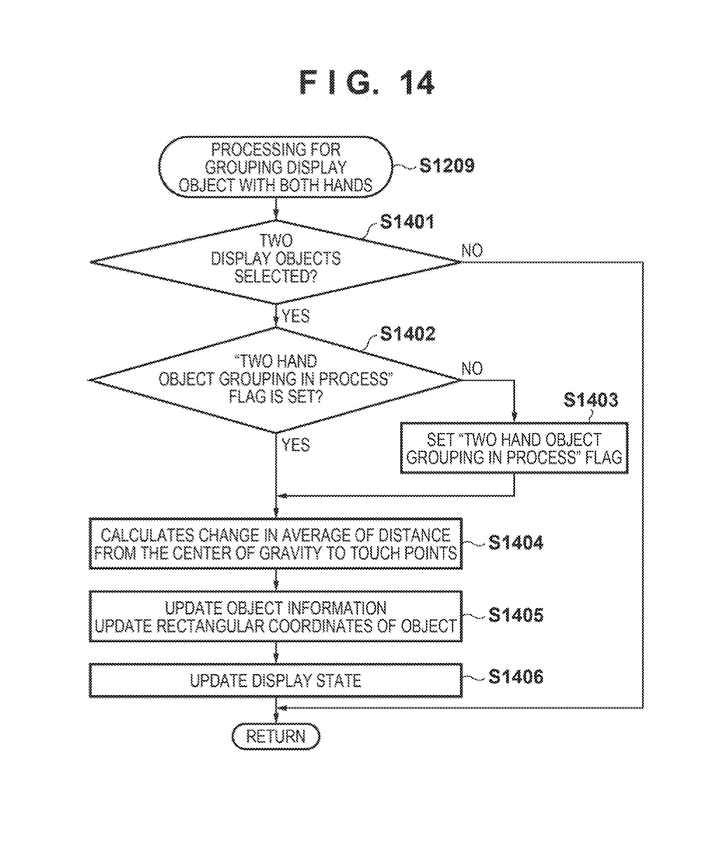

On the other hand, in step S1207, the delete processing module 1111 determines whether or not the detected event is a three or more finger move event. If so, the procedure advances to step S1208, and otherwise the procedure returns to step S1201 to wait for generation of an event. In step S1208, the delete processing module 1111 checks whether or not the number of touch points is six or more based on the information included in the three or more finger move event. If so, the procedure advances to step S1209, and otherwise the procedure advances to step S1210. In step S1209, the delete processing module 1111 executes processing for grouping display objects with both hands. This processing is executed by the two hand object grouping processing unit 1115 of the three or more finger move event processing section 1114 in the delete processing module 1111. The flowchart of this processing will be described with reference to FIG. 14. With this, the processing for grouping display objects with both hands in step S1209 ends, and the delete processing module 1111 returns the procedure to step S1201.

Also, in step S1210, the delete processing module 1111 obtains the latest touch points and the last touch points and the coordinates of the centroid that are included in the event. Next, based on this obtained information, it is determined whether or not the average value of the distance from the centroid to each point has changed between the last touch points and the latest touch points. That is, it is determined whether or not the multipoint pinch-in operation as illustrated in FIG. 20C has been executed. Assuming here that at the current point of time t, Fi(t) denotes the coordinates of each of latest touch points (where i: 1 to I, and I denotes the number of the latest touch points), and G(t) denotes the coordinates of the latest centroid that is calculated from the coordinates of the latest touch points, the average value av(t) of the distances from the latest centroid to each of the touch points is expressed with the following equation.

av(t)=Σᵢ₌₁^{i=I}(|Fi(t)−G(t)|)/I Equation (1)

where |Fi(t)−G(t)| indicates the distance between two points.

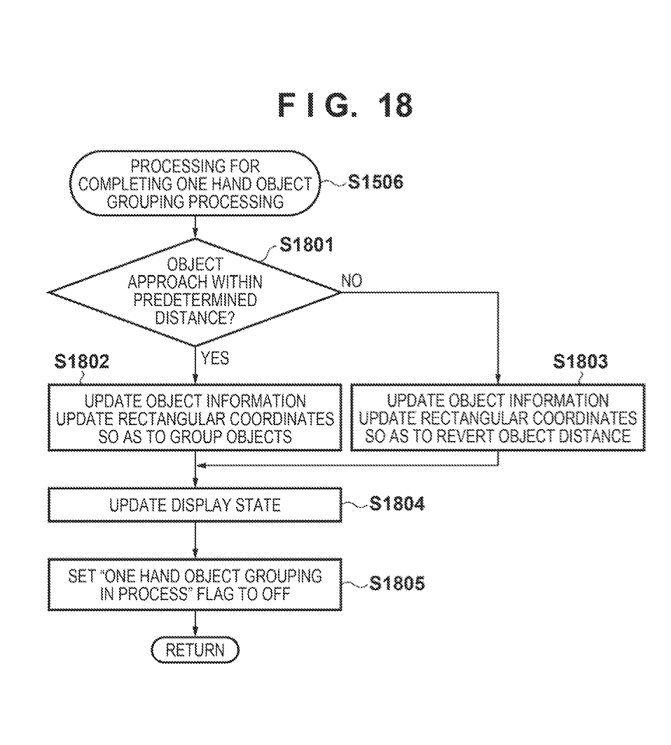

It is sufficient here to check whether or not the average value av(t−1) of the distance from the last centroid to each touch point differs from av(t) ((t−1) denotes the last information). If they differ from each other, the delete processing module 1111 advances the procedure to step S1211 where processing for deleting display objects with one hand is executed, and if they are the same, the procedure shifts to step S1212. In step S1211, the delete processing module 1111 executes processing for deleting display objects with one hand. This processing is executed by the one hand object delete processing section 1117 of the delete processing module 1111. The flowchart of this processing will be described with reference to FIG. 18. When this procedure ends, the delete processing module 1111 returns the procedure to step S1201.

In step S1212, the delete processing module 1111 checks the last and the latest touch points obtained from the event, and determines whether or not the touch points have moved in parallel to each other. For this, it is sufficient to check whether the following three conditions are satisfied simultaneously.

(1) av(t) and av(t−1) expressed in Equation (1) do not differ from each other.

(2) A slop from the centroid to each touch point does not change greatly.

(3) The centroid shifts in the x-axis direction.

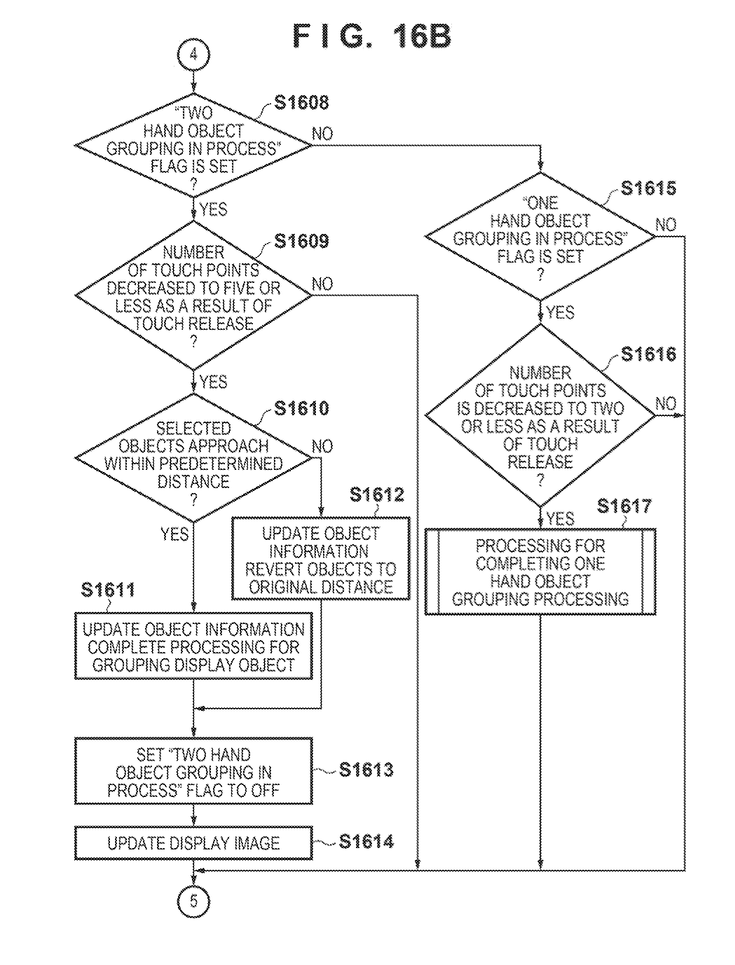

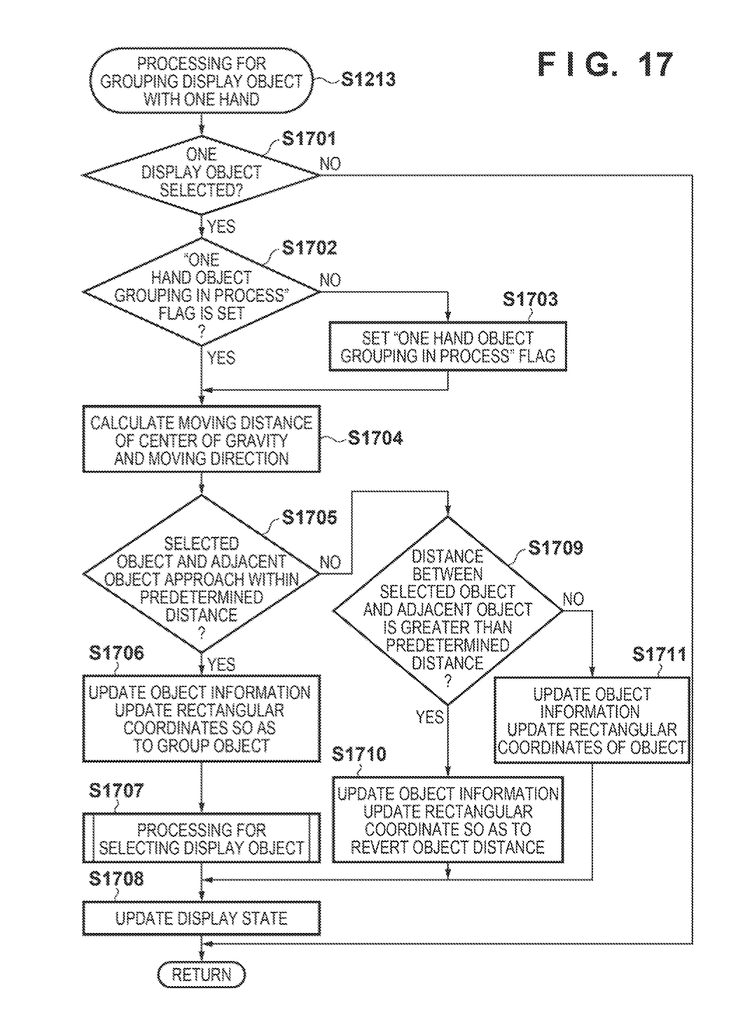

If these conditions are satisfied, the delete processing module 1111 advances the procedure to step S1213, and if these items are not satisfied, the procedure returns to step S1201. In the case where these items are not satisfied, a rotation process by multipoint touch is conceivable but it is not used in the first embodiment, so this processing is not defined here. In step S1213, the delete processing module 1111 executes processing for grouping display objects with one hand. This processing will be described in detail in a second embodiment. This processing is executed by the one hand object grouping processing unit 1116 of the delete processing module 1111. The flowchart of this processing will be described with reference to FIG. 17. When step S1213 ends, the delete processing module 1111 returns the procedure to step S1201.

By repeatedly executing the above-described procedures, it is possible to process an event according to the present embodiment among the events generated by the gestural event generation section 2100.

FIG. 13A is a flowchart for describing processing for selecting a display object (step S1203 in FIG. 12A) according to the first embodiment. The processing of this flowchart is executed by the touch event processing section 1112.

First, in step S1301, the touch event processing section 1112 determines, with respect to each set of the rectangular coordinates, whether or not there are three or more touch points within the display region of a display object. This is to determine whether or not three fingers are present within the region of one display object (see FIG. 22). “Display region of a display object” refers to a rectangular region whose upper left corner is at the rectangular coordinates of FIG. 23, and that has a horizontal length of X and a vertical length of Y. Also, “touch point” refer to the latest touch point that can be obtained as additional information of the touch event. In step S1301, if it is determined that there are three or more touch points within the display region of the display object, the procedure advances to step S1302, and the touch event processing section 1112 sets the selection flag of the object information of the display object that includes three or more touch points within the display region to “TRUE”. This corresponds to the object information of FIG. 19C. In FIG. 19C, the objects 2 and 5 are selected. Next, the procedure advances to step S1303, and the touch event processing section 1112 requests the drawing section 2300 to update the display state. Accordingly, the drawing section 2300 updates the image on the touch UI 1500 on the basis of the object information. An example of a display screen on which the object information of FIG. 19C is reflected is shown in FIG. 22 with display objects 2902 and 2905.

FIG. 13B is a flowchart for describing cancellation of selection of a display object (step S1206 in FIG. 12A). The processing of this flowchart is executed by the touch release event processing section 1113.

First, in step S1310, the touch release event processing section 1113 determines, with respect to all objects, whether or not there is an object whose selection flag is “TRUE”. If there is an object whose selection flag is “TRUE”, the procedure advances to step S1311, and otherwise the procedure ends. In step S1311, the touch release event processing section 1113 determines, with respect to each object whose selection flag is “TRUE”, whether or not there are three or more touch points within a rectangular region whose corners are rectangular coordinates. If all the objects include three or more touch points, the procedure ends, and otherwise the procedure shifts to step S1312. In step S1312, the touch release event processing section 1113 sets the selection flag of the object that has not include three or more touch points within its rectangular region to “FALSE”. Then, the procedure advances to step S1313, and the touch release event processing section 1113 requests the drawing section 2300 to update the display of this display object. Accordingly, in the example of FIG. 22, the display of the display objects 2902 and 2905 selected with three fingers up to that time is reverted to the normal display before the selection.

FIG. 14 is a flowchart for describing processing for grouping display objects with both hands of the first embodiment (step S1209 in FIG. 12B). This processing is executed by the two hand object grouping processing unit 1115. This processing is to be executed when the left hand 2907 and the right hand 2908 move in a direction of an arrow 2911 in the state of FIG. 22.

First, in step S1401, the two hand object grouping processing unit 1115 determines whether or not two display objects are currently selected. At this time, it is sufficient to check whether there are a plurality of objects for which the selection flag of the object information is set, and whether these objects have rectangular coordinates of two types in total. For example, in FIG. 19C, the objects 2 and 5 have their selection flags set and have two types of the rectangular coordinates C2 and C5. If it is determined in step S1401 that two objects are selected, the procedure advances to step S1402, and otherwise the procedure ends. In step S1402, the two hand object grouping processing unit 1115 determines whether or not a “two hand object grouping in process” flag has been set. This flag is a state flag for managing the current state of the delete processing module 1111, and is stored in a predetermined region of the RAM 1107. In addition to this state flag, there are a “deletion in process” flag for managing whether or not deletion is in process, and a “one hand object grouping in process” flag for managing whether or not processing for grouping display objects with one hand is in process. If the “two hand object grouping in process” flag has been set, the procedure advances to step S1404, and otherwise the procedure shifts to step S1403 to set the “two hand object grouping in process” flag to on and then advances to step S1404. In step S1404, the two hand object grouping processing unit 1115 calculates Δav(t), which is the change in the average value of the distances from the centroid to the touch points between the latest information and the last information. Assuming that t denotes the current (latest) point of time based on Equation (1), Δav(t) is given in the following equation:

Δav(t)=av(t)−av(t−1) Equation (2)

Next, the procedure advances to step S1405, and the two hand object grouping processing unit 1115 updates the object rectangular coordinates of the object information on the basis of Δav(t). For example, in the case of FIG. 19C, the x-coordinate C1x of the display object 2901 that is located on the left side of the coordinates C2 of the display object 2, and the coordinate C2x of the display object 2902 are respectively changed to C1x=C1x+Δav(t) and C2x=C2x+|Δav(t)|. Also, with respect to the rectangular coordinates on the right side of the coordinates C5, it is possible to shift the display object on the right side of the coordinates C5 in the left direction by defining that Cjx=Cjx−|Δav(t)| (where j is an integer of >5). Also, with respect to the rectangular coordinates of the display objects 2903 and 2904 located between the coordinates C2 and C5, it is possible to assign these display objects uniformly/equidistantly between the coordinates C2 and C5 by defining that C3x=C2x+|C2x−C5x|/3 and C4x=C2x+2|C2x−C5x|/3 (where C2x and C5x are updated coordinates). Then, the procedure advances to step S1406, and the two hand object grouping processing unit 1115 requests the drawing section 2300 to update the display based on the object information.

By repeatedly executing this procedures, it is possible to display an aspect in which the user moves his/her two hands 2907 and 2908 closer to each other on the touch panel 1300 (see FIG. 22) so that the display objects are grouped, together with the movement of the two hands.

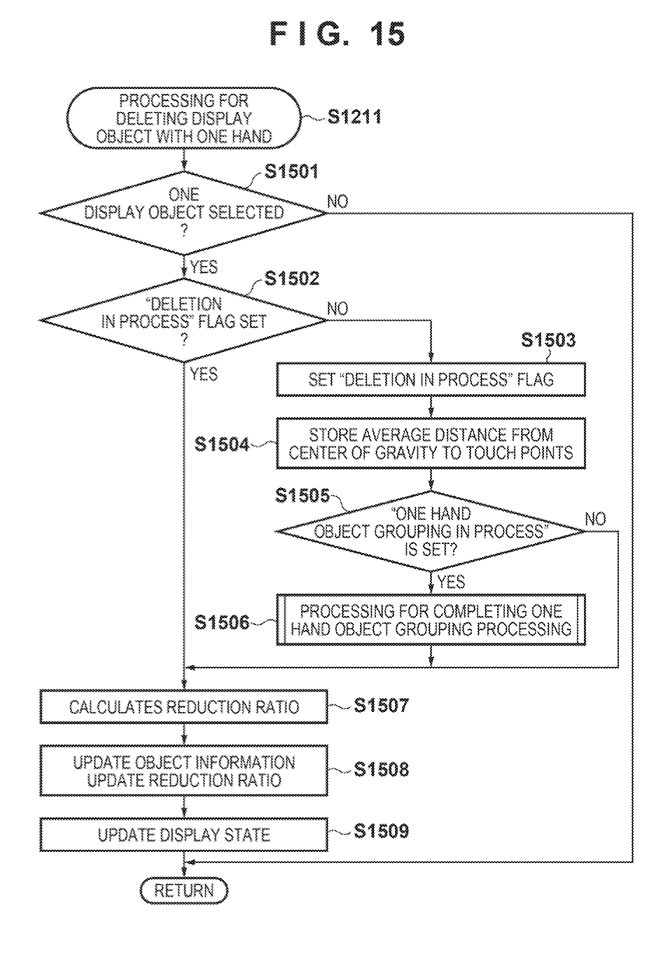

FIG. 15 is a flowchart for describing processing for deleting display objects by a multipoint pinch-in operation with one hand (step S1211 in FIG. 12B) of the first embodiment. This processing is executed by the one hand object delete processing section 1117. This processing illustrates processing in which, as illustrated by reference numeral 2608 in FIG. 20C, display objects are deleted by the multipoint pinch-in operation with the right hand 2606.

First, in step S1501, the one hand object delete processing section 1117 checks whether or not one display object is selected. At this time, the one hand object delete processing section 1117 determines whether there are objects that have selection flag of their object information set, and whether these object have rectangular coordinates of only one type. For example, in the state of FIG. 19D, the objects 2 to 5 have their selection flags set. These rectangular coordinates are cp1 of only one type (see FIG. 23). This shows that the objects 2 to 5 are grouped by the two hand grouping processing or the like and displayed as one display object within the same rectangle, and that this one display object is selected. Here, if one display object is selected, the procedure advances to step S1502, and otherwise the procedure ends.

In step S1502, the one hand object delete processing section 1117 determines whether or not the “deletion in process” flag, which is the above-described state flag, is in an ON-state. If the flag is in an ON-state, the procedure advances to step S1507, and if the flag is not in an ON-state, the procedure shifts to step S1503. In step S1503, the one hand object delete processing section 1117 sets “deletion in process” flag. Next, the procedure advances to step S1504, and the one hand object delete processing section 1117 calculates the average of the distances from the centroid immediately before the event generation to the respective touch points. This calculation is given by Equation (1). Here, the calculated av(t−1) is the value immediately before the execution of the one hand object delete processing, and is therefore stored in the RAM 1107 as av(0).

Next, the procedure advances to step S1505, and the one hand object delete processing section 1117 determines whether or not the “one hand object grouping in process” flag has been set, which is an already described state flag. This operation is executed here because the procedure needs to shift to the delete processing after the one hand object grouping processing has been completed, as will be described in the second embodiment. Here, the “one hand object grouping in process” flag is in an OFF-state, and therefore the procedure advances to the step S1507. If the “one hand object grouping in process” flag is in an ON-state, the procedure advances to step S1506 to execute processing for completing the one hand object grouping processing. This processing will be described in the second embodiment, with reference to FIG. 18.

In step S1507, the one hand object delete processing section 1117 calculates a reduction ratio using av(0) and the average value av(t) of the distances from the latest centroid to respective touch points. This reduction ratio is a ratio that indicates how much degree the display object delete processing advances, assuming that the original display state of the display object is “1”. The reduction ratio of “0” indicates that the delete processing has been completed. Here, the reduction ratio is expressed by av(t)/av(0).

Next, the procedure advances to step S1508, and the one hand object delete processing section 1117 performs display control so that the calculated reduction ratio is reflected in the displayed object. For example, FIG. 19E illustrates a state in which the area of the object has been reduced by the reduction ratio of “0.3” by performing the multipoint pinch-in (a pinching action with three or more fingers) with respect to the state of FIG. 19D. Then the procedure advances to step S1509, the one hand object delete processing section 1117 requests the drawing section 2300 to update the display state of the display object 2608 in accordance with the object information.

By repeatedly executing these procedures, it is possible to display the process of the delete processing when the multipoint pinch-in operation is performed on the display object as illustrated in, for example, FIG. 20C.

FIGS. 16A and 16B are flowcharts for describing processing for completing operations of the first embodiment (step S1205 in FIG. 12A). The two hand object grouping processing and the one hand object delete processing, which have previously been described, will not be completed, with respect to the display object, until this processing is executed. By executing this processing, the operation results are ultimately determined. This processing is executed by the touch release event processing section 1113.

First, in step S1601, the touch release event processing section 1113 determines whether or not the “deletion in process” flag is currently set. If the flag has been set, the procedure advances to step S1602, but otherwise the procedure advances to step S1608 (FIG. 16B). In step S1602, the touch release event processing section 1113 checks the object information and determines whether or not the number of the touch points that are located within a rectangle region becomes two or less by the touch release event. This shows that even if the touch was released, the delete processing has not been completed as long as display objects for which the delete processing is in process are selected. If the number of such touch points is two or less, the procedure advances to step S1603, and otherwise the procedure ends. In step S1603, the touch release event processing section 1113 checks the object information, and determines whether or not the reduction ratio of the selected display objects is a predetermined value or less. If the reduction ratio is a predetermined value or less, it is determined that the delete operation by the user has been completed, and the procedure advances to step S1604, and otherwise the procedure shifts to step S1605. In step S1604, the touch release event processing section 1113 updates the object information of the selected display object and completes the delete processing, before advancing the procedure to step S1606. At this time, the reduction ratio of the object information is changed to “0”. At this time, it is also possible to delete the corresponding object from the object information as well as the substance of the actual object.

On the other hand, in step S1605, the touch release event processing section 1113 updates the object information of the selected display object, and reverts the reduction ratio of the object information to “1”, before advancing the procedure to step S1606, where the touch release event processing section 1113 sets the “deletion in process” flag to off. Next, the procedure advances to step S1607, and the touch release event processing section 1113 requests the drawing section 2300 to update the display image based on the updated object information. This corresponds to the case, for example, where the user released his or her finger from the touch panel 1300, without shifting from the state of FIG. 20B to the multipoint pinch-in operation. This is processing for completing the one hand display object delete processing.

If the “deletion in process” flag has not been set in step S1601, the procedure advances to step S1608, and the touch release event processing section 1113 checks whether or not the “two hand object grouping in process” flag has been set. If it has been set, the procedure advances to step S1609, but otherwise the procedure shifts to step S1615. In step S1609, as with the processing in step S1602, the touch release event processing section 1113 determines whether or not the number of touch points has decreased to five or less as a result of the touch release. If the number is five or less (fingers on both hands of the user are not touching), the procedure advances to step S1610, and otherwise the procedure ends. In step S1610, the touch release event processing section 1113 checks the object information as a result of the touch release, and determines whether or not the two display objects that currently have their selection flags set approach within a predetermined distance of each other. The distance between the two display objects can be obtained by calculating the x-coordinates of the rectangular coordinates. For example, assuming that the x-coordinate of the rectangular coordinates of the object 2 is C2x and the x-coordinate of the rectangular coordinates of the object 5 is C5x, a distance d25 between the two display objects is expressed by d25=|C5x−C2x|. If this distance is less than a predetermined distance, it is determined that the display objects are grouped as illustrated in FIG. 20B, and the procedure advances to step S1611, and otherwise the procedure shifts to step S1612. In step S1611, the touch release event processing section 1113 updates the object information so as to complete the processing for grouping display objects. At this time, the coordinates of the two objects that have their selection flags set and the rectangular coordinates of objects located therebetween are set to the same rectangular coordinates. For example, assuming that the distance d25 denotes a distance between the current objects 2 and 5, the x-coordinate Cp1x of the grouped coordinates Cp1 can be calculated as follows: Cp1x=C2x+d25. By applying the result to the rectangular coordinates of the display objects 2 to 5, an image of the grouped display objects is displayed at the time of display, as illustrated in FIG. 20B.

On the other hand, in step S1612, since no operation for grouping the selected display objects has been performed, the touch release event processing section 1113 updates the object information so as to revert the display of the display object to the original display. At this time, the rectangular coordinates of objects are spaced equidistantly by D between the objects that have their selection flags set. Here, D denotes an initial value of the distance between sets of rectangular coordinates as described with reference to FIG. 23. Accordingly, the procedure advances to step S1613, and the touch release event processing section 1113 sets the “two hand object grouping in process” flag to off. Next, the procedure advances to step S1614, and the touch release event processing section 1113 requests the drawing section 2300 to update the display, similarly to when updating other display images. With these procedures, the processing for grouping a plurality of display objects with both hands can be completed. Note that procedures in steps S1615 onward will be described in the second embodiment.

By repeatedly executing these procedures, it is possible, with a series of operations, to execute processing for grouping a plurality of display objects with both hands and for collectively deleting the grouped display objects with a multipoint pinch-in operation.

According to the first embodiment, it is also possible to group a plurality of display objects on a screen with both hands and collectively delete these grouped objects by a multipoint pinch-in operation. This allows a plurality of displayed objects to be collectively deleted with a simple operation.

### Second Embodiment

The above-described first embodiment has described an embodiment in which a plurality of display objects are grouped together by both hands, and are collectively deleted by a multipoint pinch-in operation. In contrast, the second embodiment describes processing for grouping a plurality of display objects with one hand. This is processing in which the user selects a display object with three points (three fingers) or more and slides the display object by one hand in the horizontal direction, thereby grouping adjacent display objects one by one. Hereinafter, the second embodiment will be described, focusing on differences from the first embodiment. Note that the configuration of an information processing apparatus according to the second embodiment is equivalent to that of the above-described first embodiment, and therefore a description thereof is omitted.

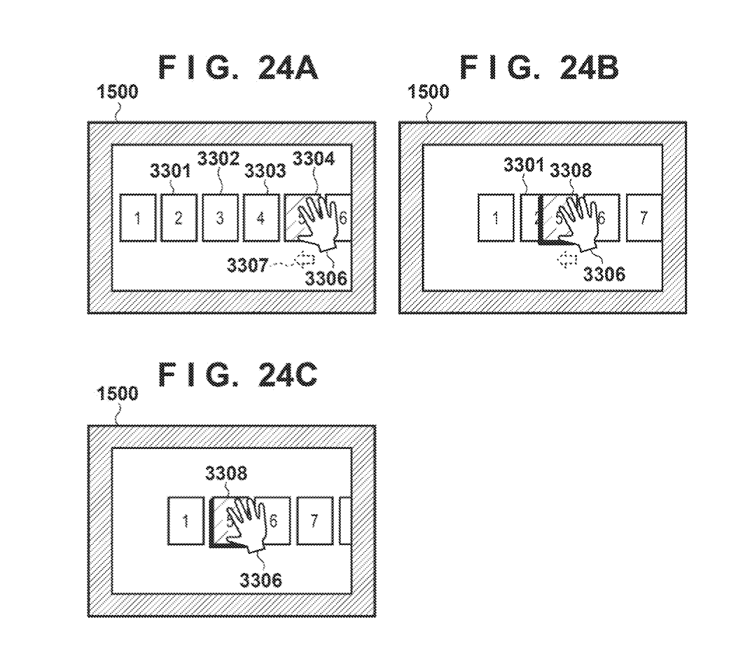

FIGS. 24A to 24C depicts views illustrating an aspect according to the second embodiment of the present invention in which a display object 3304, which corresponds to the object 5, is selected with one hand 3306 and directly shifted in the left direction as shown by an arrow 3307, thereby grouping other objects 3302-3303 up to a display object 3301, which corresponds to the object 2, one by one. Hereinafter, the operation for deleting the display objects with the multipoint pinch-in operation on a grouped object 3308 is equivalent to that of the above-described first embodiment, and therefore a detailed description thereof is omitted.

The flowchart of the overall procedures of this processing is illustrated in FIGS. 12A and 12B, as with in the above-described first embodiment. The difference from the first embodiment is that, when in step S1212 in FIG. 12B, it is determined that a plurality of touch points move in parallel to each other on the touch panel 1300, the processing in step S1213 is additionally performed. This processing in step S1213 is described with reference to the flowchart of FIG. 17.

FIG. 15 is a flowchart for describing processing for deleting display objects with one hand. The difference from the above-described first embodiment is that when, in step S1505, the “one hand object grouping in process” flag is in an ON-state, the processing for completing the one hand object grouping processing in step S1506 is executed. The details of the processing for completing the one hand object grouping processing will be described with reference to FIG. 18.

Also, the flowchart of the processing for completing operations is illustrated in FIGS. 16A and 16B, as with in the first embodiment. The difference from the first embodiment is that the processes in steps S1615 to S1617 are additionally executed. The processes in steps S1615 to S1617 that constitute a difference from the first embodiment will be described with reference to FIGS. 16 and 18.

First, the process for grouping display objects with one hand in step S1213 of FIG. 12B will be described with reference to FIG. 17.

FIG. 17 is a flowchart for describing processing for grouping display objects with one hand (in step S1213 of FIG. 12B) according to the second embodiment of the present invention. This processing is executed by the one hand object grouping processing unit 1116.

First, in step S1701, the one hand object grouping processing unit 1116 determines whether or not one display object is selected, as with in step S1501 in FIG. 15. If one display object is selected, the procedure advances to step S1702, and otherwise the procedure ends. In step S1702, it is determined whether or not the “one hand object grouping processing in process” flag, which indicates whether or not the early described process for grouping display objects with one hand is in process, is in an ON-state. If the flag is in an ON-state, the procedure advances to step S1704, and if the flag is not in an ON-state, the procedure advances to step S1703, in which the “one hand object grouping in process” flag is turned on, before advancing to step S1704. In step S1704, AG(t) is calculated, which is the moving distance of the center of gravity of the touch points touched by one hand. Here, assuming that, from Equation (3), G(t) denotes the latest coordinate values of the center of gravity, and G(t−1) denotes the last coordinate values of the center of gravity, ΔG(t) is expressed by the following formula.

ΔG(t)=G(t)−G(t−1) Equation (3)

Next, the procedure advances to step S1705, in which the pieces of object information of FIGS. 19A to 19E are checked and it is determined whether or not the display object that currently has the selection flag set and the adjacent display object approach within a predetermined distance of each other. The method for calculating the distance between two display objects is equivalent to that in step S1610 of FIG. 16B, and therefore a description thereof is omitted. If these two display objects approach within the predetermined distance of each other, the procedure advances to the step S1706, and otherwise the procedure shifts to step S1709. In step S1706, the one hand object grouping processing unit 1116 updates, for example, the rectangular coordinates of the object information of FIG. 19C on the basis of ΔG(t). Here, in order to stack the selected display object on the adjacent display object, the rectangular coordinates of the selected display object are set to the same rectangular coordinates as the adjacent display object, and rectangular coordinates of other display objects are displaced. Next, the procedure advances to step S1707, and processing for selecting a display object is executed. This processing is executed by the touch event processing section 1112 of the delete processing module 1111. The flowchart of the processing for selecting display objects has been described with reference to FIG. 13. In this way, when the processing in step S1707 ends, the procedure advances to step S1708 in which the display state of the display objects is updated and the updated display state is displayed.

On the other hand, in step S1709, the pieces of object information illustrated in FIGS. 19A to 19E are checked, and it is determined whether or not the distance between the display object that currently has its selection flag set and the adjacent display object has is greater than the predetermined distance. The method for calculating the distance between two display objects is the same as in step S1610 in FIG. 16B and therefore a description thereof is omitted. If the distance is greater than the predetermined distance, the procedure advances to step S1710, and otherwise the procedure advances to step S1711. In step S1710, the one hand object grouping processing unit 1116 updates the rectangular coordinates of the object information on the basis of ΔG(t). Here, the rectangular coordinates of all display objects are updated so that the distance between the selected display object and the other display object reverts to the initial distance.

On the other hand, in step S1711, the one hand object grouping processing unit 1116 updates the rectangular coordinates of the display object information on the basis of ΔG(t), as illustrated in FIG. 19D. Here, the rectangular coordinates of the selected display object are updated to the rectangular coordinates moved in the moving direction by ΔG(t). Accordingly, the procedure advances to step S1708, and the one hand object grouping processing unit 1116 requests the drawing section 2300 to update the display object based on the object information updated in step S1711.

By repeatedly executing these procedures, it is possible to display an aspect in which display objects are grouped, in accordance with movement of one hand.

Next, the flow of the processing for completing operations in steps S1615 to S1617 in FIG. 16B, which constitute differences from the first embodiment, will be described with reference to FIGS. 16A and 16B.

FIGS. 16A and 16B are flowcharts of the processing for completing operations. The one hand object grouping processing will not be completed, with respect to the display object, until this processing is executed, and the execution of this processing ultimately determines the operation results. This processing is executed by the touch release event processing section 1113. Hereinafter, the difference from the first embodiment will be described.

In step S1615, it is determined whether or not the “one hand object grouping in process” flag, which indicates whether or not the previously described processing for grouping display objects with one hand is in process, is in an ON-state. If the flag is in an ON-state, the procedure advances to step S1616, and otherwise the procedure ends. In step S1616, as with the processing in step S1602, it is determined whether or not the number of touch points has decreased to two or less as a result of the touch release. If the number of touch points is two or less, the procedure advances to step S1617, and otherwise the procedure ends. In step S1617, the processing for completing the one hand object grouping processing is executed, and the processing for completing operations ends. The processing for completing the one hand object grouping processing is described with reference to the flowchart of FIG. 18.

Next, the flow of the processing for completing the one hand object grouping processing in step S1617 in FIG. 16B, which constitutes a difference from the first embodiment, will be described with reference to FIG. 18.

FIG. 18 is a flowchart for describing processing for completing the process for grouping display objects with one hand according to the second embodiment (in step S1506 in FIG. 15 and step S1617 in FIG. 17). This processing is executed by the touch release event processing section 1113.

First, in step S1801, the touch release event processing section 1113 checks the object information and determines whether or not the display object whose selection flag is currently “TRUE” (ON) and the adjacent display object approach within a predetermined distance of each other. The method for calculating the distance between two display objects is the same as in step S1610 in FIG. 16B, and therefore description thereof is omitted. If they approach within the predetermined distance of each other, the procedure advances to step S1802, and otherwise the procedure shifts to step S1803. In step S1802, the rectangular coordinates of the object information are updated based on ΔG(t), which is the latest coordinate value of the center of gravity. The details of the update are the same as in step S1706 in FIGS. 17, and therefore a description thereof is omitted. If these two display objects do not approach within the predetermined distance of each other, in step S1803, the rectangular coordinates of the object information are updated based on ΔG(t), which is the latest coordinate value of the center of gravity. The details of this update are the same as in step S1710 in FIG. 17, and therefore a description thereof is omitted. Then, the procedure advances to step S1804, and the drawing section 2300 is requested to update the display object based on the object information. Next, the procedure advances to step S1805, in which the “one hand object grouping in process” flag is turned off, and the processing for completing the one hand object grouping processing ends. With the above-described procedures, the processing for grouping a plurality of display objects with one hand can be completed.

As has been described above, according to the second embodiment, it is possible to group a plurality of display objects on a touch panel with one hand, without using both hands, and delete objects that correspond to these grouped display objects altogether with simple operations as described in the first embodiment.

As has been described above, according to the present embodiments, it is possible to classify operations into operations with both hands and operations with one hand depending on the number of fingers that touch a touch UI, so that a plurality of objects can be collectively deleted. Accordingly, an operation for grouping a plurality of objects and an operation for collectively deleting the grouped objects can be executed with a series of operations. This achieves the effect of improving operability when deleting objects displayed on a screen.

### Other Embodiments

In the first and second embodiments, display objects that are to be grouped together are specified on the condition that three or more touch points are present within a display region of a display object. However, a configuration is also possible in which, even if three or more touch points are not present within the display region of one (one page of a) display object, the operation for grouping display objects can be executed as long as three or more touch points are present within the entire touch panel (or the entire display region). That is, even if all the coordinates of points touched by the finger 2909 or 2910 in FIG. 22 are not included in the display object 2902 or 2905, these display objects may be selected and grouped. For example, it is assumed that points indicated by two fingers of the three fingers 2909 are located within the display object 2902, and a point indicated by the other finger thereof is located within the other display object 2901. It is further assumed that points indicated by two fingers of the right hand fingers 2910 are located within the display object 2905, and a point indicated by the other finger thereof is located within the display object 2906. In this case, when a gesture operation is performed in a direction indicated by an arrow 2911, the object 1 (the first page) to the object 6 (the sixth page) (display objects 2901 to 2906) are grouped together. That is, the display object that includes, among the three touch points, the point located at the furthest position from the center may be decided to be the end of the objects to be grouped. This also applies to the grouping operation with one hand in the second embodiment.

Although, in the first and second embodiments, an example has been taken in which by deleting display objects with a multipoint pinch-in operation, the corresponding objects are deleted, the operation for deleting display objects is not limited to the multipoint pinch-in. For example, the operation can be realized by another gesture operation with one or two point touch, pressing a delete button, or the like.

Also, the first embodiment and the second embodiment can arbitrarily be combined with each other.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-131394, filed Jun. 8, 2012, which is hereby incorporated by reference herein in its entirety.

What is claimed is:

1. An information processing apparatus equipped with a display unit having a touch panel, comprising:
a grouping unit configured to display, in response to a plurality of touch points of at least one display object that is being touched among a plurality of display objects displayed on the display unit moving in the same direction, the touched display object so as to move in the direction, and to display the moving display object and a plurality of display objects displayed within a predetermined distance thereof, as a grouped display object; and
a deleting unit configured to execute delete processing for deleting objects that correspond to the plurality of display objects grouped by the grouping unit, by a user operation performed on the grouped display object displayed by the grouping unit.

2. The information processing apparatus according to claim 1, further comprising:
a deletion displaying unit configured to reduce, at the time of the delete processing, a size of the grouped display object, and to perform display of a process of the delete processing.

3. The information processing apparatus according to claim 1,
wherein the grouping unit includes:
a determination unit configured to determine, according to the number of touch points indicating positions of the display object that are being touched by fingers of the user, whether the operation is a two-handed operation or a one-handed operation by the user; and
a display control unit configured, if it is determined by the determination unit that the operation is the two-handed operation by the user, to display, in accordance with a gesture for moving two display objects that are touched and selected by fingers of the user in directions approaching each other, the grouped display object that includes display objects between the two display objects and includes the two display objects, and
if it is determined by the determination unit that the operation is the one-handed operation by the user, to display the grouped display object that includes one display object touched and selected by fingers of the user and a display object displayed within a predetermined distance thereof, in accordance with a gesture for moving the one display object.

4. The information processing apparatus according to claim 1,
wherein the deleting unit is configured to execute the delete processing for deleting the grouped plurality of display objects and the objects that correspond to the plurality of display objects, by a gesture of a plurality of fingers of the user performed with respect to the grouped display object displayed by the grouping unit.

5. The information processing apparatus according to claim 4,
wherein the gesture performed by the plurality of fingers of the user is a multipoint pinch-in.

6. The information processing apparatus according to claim 1,
wherein the grouping unit is configured to group, when the plurality of touch points move in parallel to each other in a state in which a distance between each of the plurality of touch points and the centroid of the touched display object does not change, a plurality of display objects that are displayed in a region in which the display object moves.

7. The information processing apparatus according to claim 3,
wherein the display control unit changes an object display mode between the grouped display object and another display object.

8. The information processing apparatus according to claim 1,
wherein the display objects are displayed so as to be arranged at a fixed interval from each other on a screen of the display unit.

9. The information processing apparatus according to claim 3,
wherein the determination unit is configured to determine that the operation is the two-handed operation by the user when a number of the touch points of one display object that is touched by the user is three or more, and a number of the touch points of the touch panel that is touched by the user is six or more.

10. A method for controlling an information processing apparatus equipped with a display unit having a touch panel, the method comprising:
a grouping step of displaying, in response to a plurality of fingers of a user that touches a display object displayed on the display unit moving in the same direction, the display object so as to move in the direction, and grouping the moving display object and a plurality of display objects displayed within a predetermined distance thereof to display a grouped display object; and
a deleting step of executing delete processing for deleting objects corresponding to the grouped display object displayed in the grouping step, by a user operation performed on the grouped display object.

11. The method according to claim 10, further comprising:
a deletion displaying step of reducing, at the time of the delete processing, a size of the grouped display object, and performing display of a process of the delete processing.

12. The method according to claim 10,
wherein the grouping step includes:
a determination step of determining, according to the number of touch points indicating positions of the display object that are being touched by fingers of the user, whether the operation is a two-handed operation or a one-handed operation by the user; and
a display controlling step of displaying, if it is determined in the determination step that the operation is the two-handed operation by the user, the grouped display object including display objects between two display objects touched and selected by fingers of the user and the two display objects, in accordance with a gesture for moving the two display objects in directions approaching each other, and
if it is determined in the determination step that the operation is the one-handed operation by the user, displaying the grouped display object including one display object touched and selected by fingers of the user and a display object displayed within a predetermined distance thereof, in accordance with a gesture for moving the one display object.

13. The method according to claim 10,
wherein in the deleting step, the delete processing for deleting objects corresponding to a plurality of display objects included in the grouped display object is executed, by a gesture of a plurality of fingers of the user performed with respect to the grouped display object displayed in the grouping step.

14. The method according to claim 13,
wherein the gesture performed by the plurality of fingers of the user is a multipoint pinch-in.

15. The method according to claim 10,
wherein in the grouping step, a plurality of display objects that are displayed in a region in which the display object moves are grouped, when the plurality of touch points move in parallel to each other in a state in which a distance between each of the plurality of touch points and the centroid of the touched display object does not change.

16. A computer-readable storage medium storing a program for causing a computer to execute the steps of the control method according to claim 10.
